(19) United States
(12) Patent Application Publication
(10) Pub. No.: US 2006/0204887 A1
(43) Pub. Date: Sep. 14, 2006

(54) Planographic printing plate precursor

(75) Inventors: Masako Imai, Shizuoka-ken (JP); Ippei Nakamura, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/355,172

(22) Filed: Feb. 16, 2006

(30) Foreign Application Priority Data
Mar. 9, 2005 (JP) 2005-066299

(51) Int. Cl. G03C 1/76

(52) U.S. Cl. 430/270.1

(57) ABSTRACT

The planographic printing plate precursor of the present invention comprises a support, an intermediate layer containing a polymer having an aromatic ring having two or more carboxylic acid groups on a side chain, which is provided on the support, and an infrared-ray layer photosensitive positive-type recording layer provided on the intermediate layer. According to the invention, a planographic printing plate precursor which can directly make plates by scanning light exposure based on a digital signal, is excellent in printing durability, and is excellent in removability of image parts not required with a removal solution.

### CROSS-REFERENCE TO RELATED APPLICATION

This application claims priority under 35 USC 119 from Japanese Patent Application No. 2005-066299, the disclosure of which is incorporated by reference herein.

### BACKGROUND OF THE INVENTION

1. Field of the Invention

The present invention relates to a positive-type planographic printing plate precursor which can record an image by light exposure of an infrared-ray laser, and in which solubility of exposed portions of a recording layer is changed. More specifically, the invention relates to a positive-type planographic printing plate precursor writable by light exposure in a near infrared region, such as by an infrared-ray laser, and, particularly a precursor that can directly make a plate from a digital signal such as a computer.

2. Description of the Related Art

In recent years, with the development of solid lasers/semiconductor lasers having a light emitting region in the near infrared to infrared, systems for directly making plates from digital data of a computer using these infrared-ray lasers have attracted attention.

As a positive-type planographic printing plate material for an infrared-ray laser for direct plate manufacturing, an image recording material in which a substance which absorbs light and produces heat, and a positive-type photosensitive compound such as quinone diazide compounds are added to an alkaline aqueous solution-soluble resin has been proposed (e.g. see Japanese Patent Application Laid-Open (JP-A) No. 7-285275). In the image parts, the positive-type photosensitive compound works as a dissolution inhibiting agent which substantially reduces solubility of the alkaline aqueous solution-soluble resin and, in the non-image parts, the compound is degraded by heat, so as not to manifest the dissolution inhibiting ability, and can be removed by development, thereby, forming an image.

Onium salts and compounds which can form a hydrogen bond network having poor alkali-solubility are known to have an effect of inhibiting dissolution of an alkali-soluble polymer in an alkali solution. As image recording materials used with an infrared laser, it is disclosed in, for example, WO97/39894 that a composition using a cationic infrared absorbing dye as a dissolution inhibitor for an alkali solution soluble polymer exhibits a positive mechanism. The positive mechanism in this image recording material refers to a the mechanism in which the infrared absorbing dye absorbs laser light to make the irradiated area of the polymer layer lose the dissolution inhibitive effect due to the generated heat to thereby form an image.

As regards a support used in such a planographic printing plate precursor, studies have been made for making the surface of the support hydrophilic to prevent the non-image area from being contaminated. For example, in the case of using a metal support such as an aluminum plate, various technologies have been reported including a method using an anodized aluminum substrate (support) and a method in which the anodized aluminum substrate is subjected to silicate treatment to raise hydrophilicity. However, various treatments for improving hydrophilicity are not necessarily superior in improving affinity to a recording layer, posing the problem that the adhesion of the support to the recording layer to be formed thereon is decreased and the recording layer peels off under harsh printing conditions, with the result that insufficient printing durability is obtained.

For this reason, a method has been proposed in which various intermediate layers are disposed between a support and a recording layer to improve the adhesion of the surface of the hydrophilicized support to the recording layer. In such a method, materials having functional groups having high affinity to resin materials constituting the recording layer and to the surface of the support are used for intermediate layers, whereby adhesion in an image area is improved and satisfactory printing durability is therefore obtained. However, there is the problem that in a non-image area, the recording layer is not removed rapidly during developing but remains as a residual layer on the surface of the support, and ink adheres to the residual layer, causing the non-image area to be contaminated. For this reason, a support is desired which has high surface hydrophilicity and satisfies both the adhesion to the recording layer in an image area and the removability of the recording layer in a non-image area.

In order to solve the aforementioned various problems, the present inventors have proposed a planographic printing plate in which an intermediate layer containing a polymer compound containing a specific structural unit such as p-vinylbenzoic acid is provided (see JP-A No. 10-69092). In addition, the present inventors have proposed a planographic printing plate precursor in which an intermediate layer containing a polymer (random polymer) having a monomer having an acid group and a monomer having an onium group is provided (see JP-A No. 2000-108538). Further, the present inventors have proposed a planographic printing plate precursor in which an intermediate layer contains a polymer having an amino acid group (see European Patent Application Publication 1459888A2).

These exert the effect of improving printing durability to some extent. However, there is a problem that the intermediate layer improves the adherability between the intermediate layer and both the support and recording layer and, as a result, after removal of the recording layer after alkali development, the intermediate layer adhered to the support is not sufficiently removed, and also a problem that when it is necessary to correct an image that after removal of an image part by treatment with removal solution (plate correcting fluid), the intermediate layer adhered to the support is not sufficiently removed, and ink is attached to the image part regions which should have been eliminated, resulting in smudged images.

### SUMMARY OF THE INVENTION

An object of the present invention, in view of the aforementioned deficiencies of the prior art, is to provide a planographic printing plate precursor which can directly make a plate by scanning light exposure based on a digital signal, and which is excellent in printing durability, and is excellent in removal of image parts not required with removal solution.

The present inventors found out by continued dedicated research that by providing an intermediate layer containing a polymer, having a specified structure on a side chain, between a support and a recording layer, the aforementioned problems can be solved, resulting in completion of the invention.

That is, the planographic printing plate precursor of the invention comprises: a support; an intermediate layer containing a polymer having on a side chain an aromatic ring having two or more carboxylic acid groups (hereinafter, for convenience, referred to as “specified polymer”), which layer is provided on the support; and an infrared-ray laser photosensitive positive-type recording layer provided on the intermediate layer. The intermediate layer and the infrared-ray laser photosensitive positive-type recording layer are sequentially provided on a support.

Herein, “sequentially provided” refers to that an intermediate layer and a recording layer are provided on a support in that order, and does not deny the presence of other layers (e.g. protective layer, back coating layer etc.) provided depending on the purpose.

The action of the invention is not clear, but is thought to be as described below.

That is, the specified polymer contained in an intermediate layer in the invention has a side chain having two or more carboxylic acid groups. For this reason, since the number of acid groups per unit monomer is increased, it is thought that the intermediate layer can interact strongly with the support surface, adherence between the support and the recording layer is improved and, thus, printing durability can be improved.

In addition, since the carboxylic acid groups in the specified polymer have excellent affinity for removal solution, it is presumed that at parts where correction of an image part is necessary, the intermediate layer together with the image part to be removed is rapidly removed with removal solution, and excellent removability is manifested while excellent printing durability of image parts is maintained.

Further, in an infrared-ray laser photosensitive positive-type recording layer, reaction does not proceed down to the vicinity of the support surface due to heat diffusion to the support during light exposure, and there are sometimes concerns about the adequacy of recording layer removal at non-image parts, but it is thought that since the specified polymer in the invention has excellent solubility in developer, the recording layer at non-image parts is easily removed.

According to the invention, a planographic printing plate precursor which can directly make plates by scanning light exposure based on digital signals, is excellent in printing durability, and is excellent in removability of image parts not required with removal solution can be provided.

### DETAILED DESCRIPTION OF THE INVENTION

The present invention will be explained in detail below.

The planographic printing plate precursor of the invention comprises a support, an intermediate layer containing a polymer having an aromatic ring having two or more carboxylic acid groups on a side chain, which is provided on the support, and an infrared-ray laser photosensitive positive-type recording layer provided on the intermediate layer.

[Intermediate Layer]

An intermediate layer containing a polymer having an aromatic ring having two or more carboxylic acid groups on a side chain (specified polymer) which is an essential feature of the invention will be explained.

A specified polymer in the invention is obtained, for example, by polymerizing or copolymerizing a monomer having an aromatic ring having two or more carboxylic acid groups by the known method.

In addition, this “aromatic ring having two or more carboxylic acid groups” refers to a ring in which hydrogen atoms on one aromatic ring are directly substituted with two or more carboxylic acid groups.

First, a monomer for obtaining a specified polymer in the invention will be explained.

[Monomer Having Aromatic Ring Having Two or More Carboxylic Acid Groups]

A monomer having an aromatic ring having two or more carboxylic acid groups (hereinafter, conveniently, referred to as “specified monomer”) is constructed by inclusion of a polymerizable double bond, and an aromatic ring having two or more carboxylic acid groups.

In addition, in a specified monomer, the polymerizable double bond and the aromatic ring having two or more carboxylic acid groups may be connected with a single bond, or may be connected with a divalent tethering group.

Examples of the aromatic ring to be substituted with two or more carboxylic acid groups include hydrocarbon-based aromatic rings such as benzene, naphthalene, phenanthrene, anthracene and pyrene, heterocyclic aromatic rings such as pyridine, triazine, furan, quinoline, isoquinoline, and 1,10-phenanthrene, and cyclic systems containing a general aromatic ring such as indene, indole, benzofuran, fluorene and dibenzofuran and, particularly, hydrocarbon-based aromatic rings such as benzene, naphthalene, phenanthrene, anthracene and pyrene are preferable.

It is necessary that these aromatic rings are substituted with two or more carboxylic acid groups, and those rings may be substituted with three or more carboxylic acid groups.

In the invention, it is preferable that an aromatic ring having two or more carboxylic acid groups is particularly phthalic acid or isophthalic acid.

The aforementioned aromatic ring may have a substituent other than a carboxylic acid group, and examples of the substituent include monovalent non-metallic atomic entities except for hydrogen, such as a halogen atom (—F, —Br, —Cl, —I), a hydroxyl group, an alkoxy group, an aryloxy group, a mercapto group, an alkylthio group, an arylthio group, an alkyldithio group, an aryldithio group, an amino group, a N-alkyl amino group, a N,N-dialkyl amino group, a N-aryl amino group, a N,N-diarylamino group, a N-alkyl-N-arylamino group, an acyloxy group, a carbamoyloxy group, a N-alkylcarbamoyloxy group, a N-arylcarbamoyloxy group, a N,N-dialkylcarbamoyloxy group, a N,N-diarylcarbamoyloxy group, a N-alkyl-N-arylcarbamoyloxy group, an alkylsulfoxy group, an arylsulfoxy group, an acylthio group, an acylamino group, a N-alkylacylamino group, a N-arylacylamino group, an ureido group, a N′-alkylureido group, a N′,N′-dialkylureido group, a N′-arylureido group, a N′,N′-diarylureido group, a N′-alkyl-N′-arylureido group, a N-alkylureido group, a N-arylureido group, a N′-alkyl-N-alkylureido group, a N′-alkyl-N-arylureido group, a N′,N′-dialkyl-N-alkylureido group, a N′,N′-dialkyl-N-arylureido group, a N′-aryl-N-alkylureido group, a N′-aryl-N-arylureido group, a N′,N′-diaryl-N-alkylureido group, a N′,N′-diaryl-N-arylureido group, a N′-alkyl-N′-aryl-N-alkylureido group, a N′-alkyl-N′-aryl-N-arylureido group, an alkoxycarbonylamino group, an aryloxycarbonylamino group, a N-alkyl-N-alkxycarbonylamino group, a N-alkyl-N-aryloxycarbonylamino group, a N-aryl-N-alkoxycarbonylamino group, a N-aryl-N-aryloxycarbonylamino group, a formyl group, an acyl group, a group consisting of a carboxyl group and a salt thereof, an alkoxycarbonyl group, an aryloxycarbonyl group, a carbamoyl group, a N-alkylcarbamoyl group, a N,N-dialkylcarbamoyl group, a N-arylcarbamoyl group, a N,N-diarylcarbamoyl group, a N-alkyl-N-arylcarbamoyl group, an alkylsulfinyl group, an arylsulfinyl group, an alkylsulfonyl group, an arylsulfonyl group, a group consisting of a sulfo group (—SO₃H) and a salt thereof, an alkoxysulfonyl group, an aryloxysulfonyl group, a sulfinamoyl group, a N-alkylsulfinamoyl group, a N,N-dialkylsulfinamoyl group, a N-arylsulfinamoyl group, a N,N-diarylsulfinamoyl group, a N-alkyl-N-arylsulfinamoyl group, a sulfinamoyl group, a N-alkylsulfamoyl group, a N,N-dialkylsulfamoyl group, a N-arylsulfamoyl group, a N,N-diarylsulfamoyl group, a N-alkyl-N-arylsulfamoyl group, a group consisting of a N-acylsulfamoyl group and a salt thereof, a group consisting of a N-alkylsulfonylsulfamoyl group (—SO₂NHSO₂(alkyl)) and a salt thereof, a group consisting of a N-arylsulfonylsulfamoyl group (—SO₂NHSO₂(aryl)) and a salt thereof, a group consisting of a N-alkylsulfonylcarbamoyl group (—CONHSO₂(alkyl)) and a salt thereof, a group consisting of a N-arylsulfonylcarbamoyl group (—CONHSO₂(alkyl)) and a salt thereof, an alkoxysillyl group (—Si(Oalkyl)₃), an aryloxysillyl group (—Si(Oaryl)₃), a group consisting of a hydroxysillyl group (—Si(OH)₃) and a salt thereof, a group consisting of a phosphono group (—PO₃H₂) and a salt thereof, a dialkylphosphono group (—PO₃(alkyl)₂), a diarylphosphono group (—PO₃(aryl)₂), an alkylarylphosphono group (—PO₃(alkyl)(aryl)), a group consisting of a monoalkylphosphono group (—PO₃H(alkyl)) and a salt thereof, a group consisting of a monoarylphosphono group (—PO₃H(aryl)) and a salt thereof, a group consisting of a phosphonooxy group (—OPO₃H₂) and a salt thereof, a dialkylphosphonooxy group (—OPO₃(alkyl)₂), a diarylphosphonooxy group (—OPO₃(aryl)₂), an alkylarylphosphonooxy group (—OPO₃(alkyl)(aryl)), a monoalkylphosphonooxy group (—OPO₃H(alkyl)) and its conjugated base group, a group consisting of a monoarylphosphonooxy group (—OPO₃H(aryl)) and a salt thereof, a cyano group, a nitro group, an aryl group, an alkyl group, an alkenyl group, and an alkynyl group.

In addition, in a specified monomer, a divalent tethering group which connects a polymerizable double bond and an aromatic ring having two or more carboxylic acid groups is a group constructed by appropriately combining the divalent hydrocarbon group, and a partial structure containing one or more hetero atoms selected from the group consisting of an oxygen atom, a nitrogen atom, and a sulfur atom. Herein, examples of the partial structure containing one or more hetero atoms include —C(═O)—, —O—, —NH—, —COO—, —CONH—, —S—, —SO₂—, —SO—, and a structure constructed by combining them. In addition, examples of a substituent which can be introduced into this divalent tethering group include the same substituents as those shown as a substituent which can be introduced into the aromatic ring.

Examples of a specified monomer in the invention include the following compounds, but the invention is not limited to them.

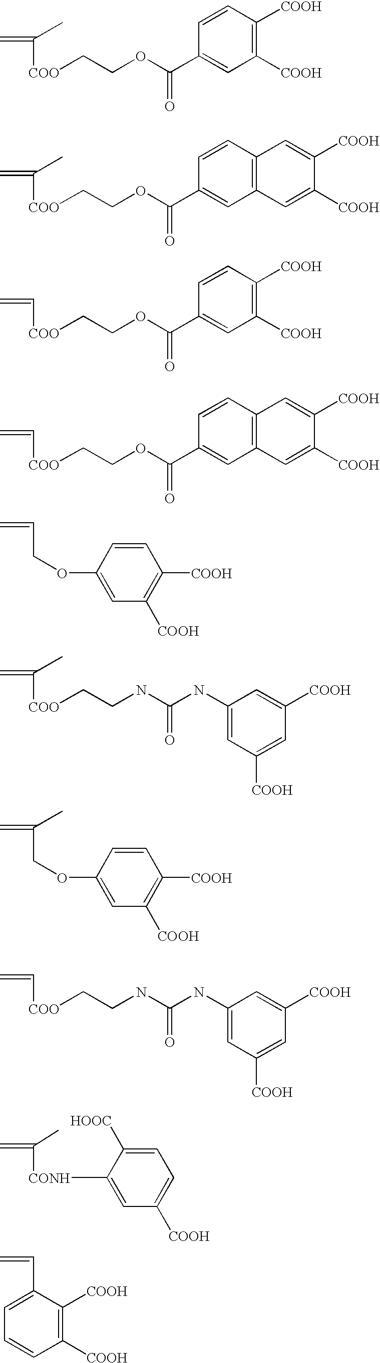

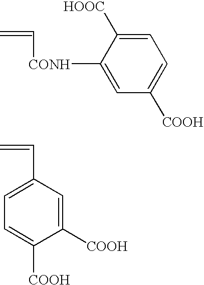

A content of the specified monomer in a specified polymer is preferably 5 mol % or more, further preferably 20 mol % or more from a viewpoint that the effect of improving printing durability due to interaction with an aluminum support is sufficiently exerted.

Only one kind, or two or more kinds of these specified monomers may be contained in a specified polymer. In addition, these specified monomers may be copolymerized with other monomer component in such a range that the effect of the invention is not deteriorated.

[Synthesis of Specified Polymer]

It is preferable that the specified polymer in the invention is synthesized by radical-polymerizing a raw material of the specified monomer and, optionally, other monomer. In addition, upon this radical polymerization, a polymerization initiator and a chain transfer agent may be used. Specifically, a specified polymer obtained by radical polymerization in the presence of a polymerization initiator at 1 mol % or more and a chain transfer agent at 0.5 mol % or more relative to a monomer raw material, is preferable.

When the specified polymer is a copolymer, it may be any of a random copolymer, a block copolymer and a graft copolymer.

A method of synthesizing the specified polymer in the invention will be explained in detail below.

-Polymerization Initiator-

For synthesizing the specified polymer, a polymerization initiator such as peroxides such as di-t-butyl peroxide, and benzoyl peroxide, persulfates such as ammonium persulfate, and an azo compound such as azobisisobutyronitrile can be used. These polymerization initiators are appropriately selected depending on an applied polymerization format.

Examples of the polymerization initiator used in synthesizing the specified polymer include azonitrile-based initiators such as 2,2′-azobis(2,4-dimethylvaleronitrile), 2,2′-azobis(4-methoxy-2,4-dimethylvaleronitrile), 2,2′-azobis(2-methylpropionitrile), 2,2′-azobis(2-methylbutyronitrile), 1,1′-azobis(cyclohexane-1-carbonitrile), 1-[(1-cyano-1-methylethyl)azo]formamido(2-(carbamoylazo)isobutyronitrile), and 2-phenylazo-4-methoxy-2,4-dimethyl-valeronitrile;

azoamidine-based initiators such as 2,2′-azobis(2-methyl-N-phenylpropionamidine) dihydrochloride, 2,2′-azobis[N-(4-cyclophenyl)-2methyl-propionamidine]dihydrochloride, 2,2′-azobis[N-(4-hydroxyphenyl)2-methylpropionamidine]dihydrochloride, 2,2′-azobis[2-methyl-N-(phenylmethyl)propionamidine]dihydrochloride, 2,2′-azobis[2-methyl-N-(2-propenyl)propionamidine]dihydrochloride, 2,2′-azobis(2-methylpropionamidine) dihydrochloride, and 2,2′-azobis[N-(2-hydroxyethyl)-2-methyl-propionamidine]dihydrochloride;

cyclic amidine-based initiators such as 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis[2-(1-(2-hydroxyethyl)-2-imidazolin-2-yl)propane]dihydrochloride, and 2,2′-azobis [2-(2imidazolin-2-yl)propane];

azoamide-based initiators such as 2,2′-azobis {2-methyl-N-[1,1-bis(hydroxymethyl)-2-hydroxyethyl]propionamide}, 2,2′-azobis {2-methyl-N-[1,1-bis(hydroxymethyl)ethyl]propionamide}, 2,2′-azobis[2-methyl-N-(2-hydroxyethyl)-propionamide], and 2,2′-azobis(2-methylpropionamide) dihydrate;

alkylazo-based initiators such as 2,2′-azobis(2,4,4-trimethylpropane), and 2,2′-azobis(2-methylpropane);

and dimethyl-2,2′-azobis(2-methylpropionate), 4,4′-azobis(4-cyanovaleric acid), and 2,2′-azobis[2-(hydroxymethyl)propionitrile].

These polymerization initiators are sold under V-70, V-65, V-60, V-59, V-40, V-30, V-19 (all azonitrile-based), VA-545, VA-546, VA-548, VA-552, VA-553, VA-50, VA-558 (all azoamidine-based), VA-041, VA-044, VA-054, VA-058, VA-059, VA-060, VA-061 (all cyclic azoamidine-based), VA-080, VA-082, VA-086, VA-088 (all azoamide-based), VR-110, VR-160 (all alkylazo-based), V-601, V-501, and VF-077 manufactured by Wako Pure Chemical Industries, Ltd., and these commercially available products can be also preferably used in synthesizing the specified polymer in the invention.

Inter alia, preferable examples include dimethyl-2,2′-azobis(2-methylpropionate) (as a commercially available product, V-601 manufactured by Wako Pure Chemical Industries, Ltd.), and 2,2′-azobis(2,4-dimethylvaleronitrile) (as a commercially available product, V-65 manufactured by Wako Pure Chemical Industries, Ltd.).

Such the polymerization initiators may be used alone, or two or more kinds may be used together depending on the purpose. An addition amount at synthesis is preferably 1 mol % or more, relative to a total amount of charged monomers, and is preferably 8 mol % or less from a viewpoint of polymerization suitability. A particularly preferable addition amount is in a range of 2 to 6.5 mol %.

-Chain Transfer Agent-

As a chain transfer agent used upon synthesis, any agent can be used without any limitation as far as it is a substance which transfers an active point of a reaction by a chain transfer reaction in a polymerization reaction. Easiness of occurrence of a transfer reaction of a chain transfer agent is expressed by a chain transfer constant Cs, and a chain transfer constant Cs×10⁴ (60° C.) of a chain transfer agent used in the invention is preferably 0.01 or more, more preferably 0.1 or more, particularly preferably 1 or more.

Examples of a chain transfer agent which can be used in the invention include halogen compounds such as carbon tetrachloride, and carbon tetrabromide; alcohols such as isopropyl alcohol, and isobutyl alcohol; olefins such as 2-methyl-1-butene, and 2,4-diphenyl-4-methyl-1-pentene; sulfur-containing compounds such as ethanethiol, butanethiol, dodecanethiol, mercaptoethanol, mercaptopropanol, methyl mercaptopropionate, ethyl mercaptopropionate, mercaptopropionic acid, thioglycolic acid, ethyl disulfide, sec-butyl disulfide, 2-hydroxyethyl disulfide, thiosalicylic acid, thiophenol, thiocresol, benzylmercaptan, and phenethylmercaptan, being not limiting.

A more preferable chain transfer agent includes ethanethiol, butanethiol, dodecanethiol, mercaptoethanol, mercaptopropanol, methyl mercaptopropionate, ethyl mercaptopropionate, mercaptopropionic acid, thioglycolic acid, ethyl disulfide, sec-butyl disulfide, 2-hydroxyethyl disulfide, thiosalicylic acid, thiophenol, thiocresol, benzylmercaptan, and phenethylmercaptan, and examples of a particularly preferable chain transfer agent include ethanethiol, butanethiol, mercaptoethanol, mercaptopropanol, methyl mercaptopropionate, ethyl mercaptopropionate, mercaptopropionic acid, thioglycolic acid, ethyl disulfide, and 2-hydroxyethyl disulfide.

These chain transfer agents may be used alone, or two or more kinds may be used together as far as the effect is not deteriorated. And, an addition amount at synthesis is preferably 0.5 mol % or more relative to a total amount of charged monomers, and is preferably 12 mol % or less in view of physical properties of the resulting polymer. A particularly preferable addition amount is in a range of 0.5 to 6.5 mol %.

-Polymerization Solvent-

Examples of a polymerization solvent used upon synthesis include acetone, methyl ethyl ketone, methanol, ethanol, propanol, ethylene glycol monomethyl ether, ethylene glycol monoethyl ether, diethylene glycol dimethyl ether, 1-methoxy-2-propanol, 2-methoxyethyl acetate, 1-methoxy-2-propyl acetate, dimethoxyethane, methyl lactate, ethyl lactate, ethyl acetate, N,N-dimethylacetamide, N,N-dimethylformamide, dimethyl sulfoxide, tetrahydrofuran, toluene, and water, being not limiting.

As a format of polymerizing the specified polymer, solution polymerization, emulsion polymerization or suspension polymerization is applied, and a solution polymerization method is preferable.

The specified polymer in the invention is adjusted to a relatively low molecular weight by the function of this chain transfer agent.

It is preferable that a weight average molecular weight of the specified polymer is in a range of 1,000 to 50,000.

[Other Monomer Components]

The specified polymer in the invention may be a polymer obtained by copolymerizing with other monomer component for the purpose of reinforcing further interaction with a support, or reinforcing interaction with a recording layer. Examples of other monomer component include “a monomer having an onium group” from a viewpoint of improving adherability with a hydrophilization-treated support, and “a monomer having a functional group which can interact with a recording layer” from a viewpoint of improving adherability with a recording layer.

(Monomer Having Onium Group)

Examples of the monomer having an onium group include monomers represented by the following formula (A) to formula (C), being not limiting.

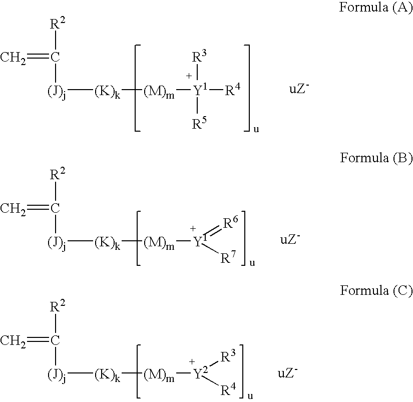

In the formulas (A) to (C), J represents a divalent tethering group. K represents an aromatic group or a substituted aromatic group. M represents a divalent tethering group. Y¹ represents an atom of Periodic Table Group V. Y² represents an atom of Periodic Table Group VI. Z⁻ represents a counteranion. R² represents a hydrogen atom, an alkyl group, or a halogen atom. R³, R⁴, R⁵ and R⁷ each represents independently a hydrogen atom, an alkyl group, an aromatic group, or an aralkyl group, and these hydrocarbon groups may further a substituent. R⁶ represents an alkylidine group, or a substituted alkylidine group. R³ and R⁴, or R⁶ and R⁷ may be taken together to form a ring. And, j, k and m each represents independently 0 or 1, and u represents an integer of 1 to 3.

Among monomers having an onium group represented by the formulas (A) to (C), a more preferable monomer is the following case.

J represents —COO— or —CONH—, and K represents a phenylene group or a substituted phenylene group. As a substituent to be introduced when K is a substituted phenylene group, a hydroxy group, a halogen atom or an alkyl group is preferable.

M is an alkylene group, or a divalent tethering group represented by the molecular formula —CₙH₂ₙO—, —CₙH₂ₙS— or —CₙH₂ₙ₊₁N—. Herein, n represents an integer of 1 to 12.

Y¹ represents a nitrogen atom or a phosphorus atom, and Y² represents a sulfur atom.

Z⁻ represents a halogen ion, PF₆—, BF₄— or R⁸SO₃—. Herein, R⁸ represents an alkyl group of a carbon number of 1 to 10, an aromatic group of a carbon number of 6 to 10, or an aralkyl group of a carbon number of 7 to 10, which may be bound with a substituent.

R² represents a hydrogen atom or an alkyl group.

R³, R⁴, R⁵ and R⁷ each represents independently a hydrogen atom, or an alkyl group of a carbon number of 1 to 10, an aromatic group of a carbon number of 6 to 10, or an aralkyl group of a carbon number of 7 to 10, which may be bound with a substituent.

It is preferable that R⁶ is an alkylidine group of a carbon number of 1 to 10, or substituted alkylidene. R³ and R⁴, or R⁶ and R⁷ may be taken together to form a ring.

And, j, k and m each represents independently 0 or 1, and it is preferable that j and k are not 0 at the same time.

Among monomers having an onium group represented by the formulas (A) to (C), a particularly preferable monomer is the following case.

K represents a phenylene group, or a substituted phenylene group and, in the case of a substituted phenylene group, a substituent thereof is a hydrogen atom or an alkyl group of a carbon number of 1 to 3.

M represents an alkylene group of a carbon number of 1 to 2, or an alkylene group of a carbon number of 1 to 2 connected with an oxygen atom.

Z⁻ represents a chlorine ion or R⁸SO₃⁻. Herein, R⁸ represents an alkyl group of a carbon number of 1 to 3.

R² represents a hydrogen atom or a methyl group, j is 0, and k is 1.

Examples of a monomer having an onium group which is preferably used in the specified polymer will be shown below, but the invention is not limited to them. 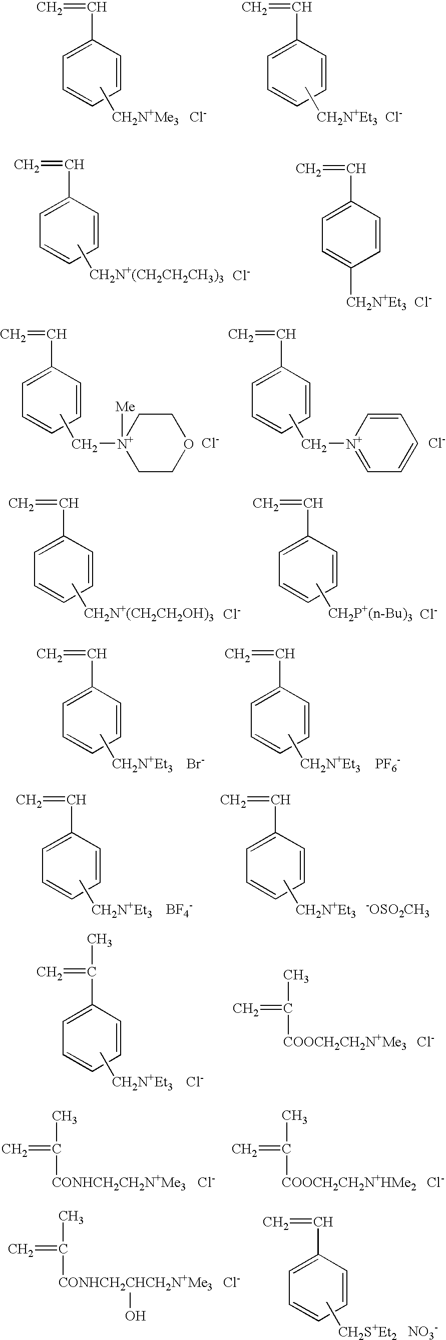 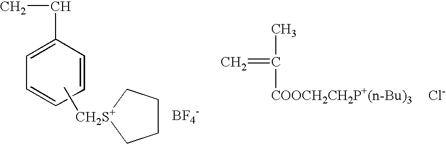
(Monomer Having Acid Group)

A monomer having an acid group which is preferably used in the specified polymer will be explained.

As an acid group contained in a monomer having an acid group, a carboxylic acid group, a sulfonic acid group or a phosphonic acid group is particularly preferable, being not limiting.

-Monomer Having Carboxylic Acid Group-

A monomer having a carboxylic acid group is not particularly limited as far as it is a monomer having a structure other than the specified monomer, which is a polymerizable compound having a carboxylic acid group and a polymerizable double bond in its structure.

Preferable examples of the monomer having a carboxylic acid group include a compound represented by the following formula (1).

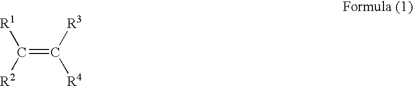

In the formula (1), R¹ to R⁴ each represents independently a hydrogen atom, an alkyl group, or an organic group represented by the following formula (2), and at least one of R¹ to R⁴ is an organic group represented by the following formula (2).

Herein, from a viewpoint of copolymerizability and raw material easy availability upon preparation of the specified polymer, R¹ to R⁴ have preferably 1 to 2, particularly preferably one organic groups represented by the following formula (2). From a viewpoint of flexibility of the specified polymer obtained as a result of polymerization, R¹ to R⁴ other than an organic group represented by the following formula (2) are preferably an alkyl group or a hydrogen atom, particularly preferably a hydrogen atom.

For the same reason, when R¹ to R⁴ are an alkyl group, an alkyl group of a carbon number of 1 to 4 is preferable, and a methyl group is particularly preferable.
—X—COOH Formual (2)
In the formula (2), X represents a single bond, an alkylene group, an arylene group optionally having a substituent, or any of groups represented by the following structural formulas (3) to (5). From a viewpoint of polymerizability and easy availability, a single bond, an arylene group, a representative of which is a phenylene group or a group represented by the following structural formula (3) is preferable, an arylene group or a group represented by the following structural formula (3) is more preferable, and a group represented by the following structural formula (3) is particularly preferable.

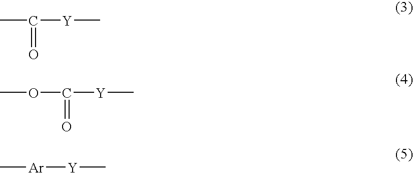

In the structural formulas (3) to (5), Y represents a divalent tethering group, and Ar represents an arylene group optionally having a substituent. As Y, an alkylene group of a carbon number of 1 to 16, or a single bond is preferable. Methylene (—CH₂—) in an alkylene group may be substituted with an ether linkage (—O—), a thioether linkage (—S—), an ester linkage (—COO—), or an amido linkage (—CONR—; R represents a hydrogen atom or an alkyl group) and, as a linkage substituting a methylene group, an ether linkage or an ester linkage is particularly preferable.

Among such the divalent tethering groups, particularly preferable examples are shown below.

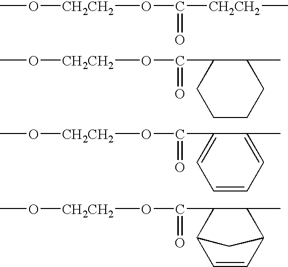

Particularly preferable examples of the monomer having a carboxylic acid group represented by the formula (1) are shown below, but the invention is not limited to them. 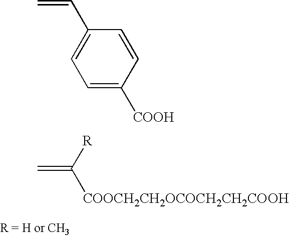
-Monomer Having Sulfonic Acid Group-

A monomer having a sulfonic acid group is not particularly limited as far as it is a polymerizable compound having a sulfonic acid group and a polymerizable double bond in its structure.

Preferable examples of the monomer having a sulfonic acid group include 3-sulfopropyl acrylate, 3-sulfopropyl methacrylate, and 4-styrenesulfonic acid.

-Monomer Having Phosphonic Acid Group-

A monomer having a phosphonic acid group is not particularly limited as far as it is a polymerizable compound having a phosphonic acid group and a polymerizable double bond in its structure.

Preferable examples of the monomer having a phosphonic acid group include acidphosphoxyethyl methacrylate, 3-chloro-2-acidphosphoxypropyl methacrylate, and acidphosphoxypolyoxyethylene glycol monomethacrylate.

(Monomer Having a Functional Group which can Interact with a Recording Layer)

Examples of a monomer having a functional group which can interact with a recording layer are shown below, but the invention is not limited to them.

(1) Acrylamides, methacrylamides, acrylic acid esters, methacrylic acid esters and hydroxystyrenes having an aromatic hydroxy group such as N-(4-hydroxyphenyl)acrylamide or N-(4-hydroxyphenyl)methacrylamide, o-, m- or p-hydroxystyrene, o- or m-bromo-p-hydroxystyrene, o- or m-chloro-p-hydroxystyrene, o-, m- or p-hydroxyphenyl acrylate or methacrylate;

(2) acrylamides such as N-(o-aminosulfonylphenyl)acrylamide, N-(m-aminosulfonylphenyl)acrylamide, N-(p-aminosulfonylphenyl)acrylamide, N-[1-(3-aminosulfonyl)naphthyl]acrylamide, and N-(2-aminosulfonylethyl)acrylamide, methacrylamides such as N-(o-aminosulfonylphenyl)methacrylamide, N-(m-aminosulfonylphenyl)methacrylamide, N-(p-aminosulfonylphenyl)methacrylamide, N-[1-(3-aminosulfonyl)naphthyl]methacrylamide, and N-(2-aminosulfonylethyl)methacrylamide, as well as unsaturated sulfonamide such as acrylic acid esters such as o-aminosulfonylphenyl acrylate, m-aminosulfonylphenyl acrylate, p-aminosulfonylphenyl acrylate, and 1-(3-aminosulfonylphenylnaphthyl) acrylate, and unsaturated sulfonamide such as methacrylic acid esters such as o-aminosulfonylphenyl methacrylate, m-aminosulfonylphenyl methacrylate, p-aminosulfonylphenyl methacrylate, and 1-(3-aminosulfonylphenylnaphthyl) methacrylate;

(3) phenylsulfonylacrylamide optionally having a substituent such as tosylacrylamide, and phenylsulfonylmethacrylamide optionally having a substituent such as tosylmethacrylamide;

(4) acrylic acid esters and methacrylic acid esters having an aliphatic hydroxy group, for example, 2-hydroxyethyl acrylate or 2-hydroxyethyl methacrylate;

(5) (substituted) acrylic acid ester such as methyl acrylate, ethyl acrylate, propyl acrylate, butyl acrylate, amyl acrylate, hexyl acrylate, cyclohexyl acrylate, octyl acrylate, phenyl acrylate, benzyl acrylate, 2-chloroethyl acrylate, 4-hydroxybutyl acrylate, glycidyl acrylate, and N-dimethylaminoethyl acrylate;

(6) (substituted) methacrylic acid ester such as methyl methacrylate, ethyl methacrylate, propyl methacrylate, butyl methacrylate, amyl methacrylate, hexyl methacrylate, cyclohexyl methacrylate, octyl methacrylate, phenyl methacrylate, benzyl methacrylate, 2-chloroethyl methacrylate, 4-hydroxybutyl methacrylate, glycidyl methacrylate, and N-dimethylaminoethyl methacrylate;

(7) acrylamide or methacrylamide such as acrylamide, methacrylamide, N-methylolacrylamide, N-methylolmethacrylamide, N-ethylacrylamide, N-ethylmethacrylamide, N-hexylacrylamide, N-hexylmethacrylamide, N-cyclohexylacrylamide, N-cyclohexylmethacrylamide, N-hydroxyethylacrylamide, N-hydroxyethylacrylamide, N-phenylacrylamide, N-phenylmethacrylamide, N-benzylacrylamide, N-benzylmethacrylamide, N-nitrophenylacrylamide, N-nitrophenylmethacrylamide, N-ethyl-N-phenylacrylamide and N-ethyl-N-phenylmethacrylamide;

(8) vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether;

(9) vinyl esters such as vinyl acetate, vinyl chloroacetate, vinyl butyrate, and vinyl benzoate;

(10) styrenes such as styrene, a-methylstyrene, methylstyrene, and chloromethylstyrene;

(11) vinyl ketones such as methyl vinyl ketone, ethyl vinyl ketone, propyl vinyl ketone, and phenyl vinyl ketone;

(12) olefins such as ethylene, propylene, isobutyrene, butadiene, and isoprene;

(13) N-vinylpyrrolidone, N-vinylcarbazole, 4-vinylpyridine, acrylonitrile, and methacrylonitrile;

(14) lactone group-containing monomer such as pantoyllactone (meth)acrylate, α-(meth)acryloyl-γ-butyrolactone, β-(meth)acryloyl-γ-butyrolactone;

(15) ethylene oxide group-containing monomer such as polyethylene glycol mono(meth)acrylate, polypropylene glycol mono(meth)acrylate, and methoxypolyethylene glycol mono(meth)acrylate.

In the specified polymer, a content of the aforementioned other monomer is preferably 50 mol % or less.

Embodiments of the specified polymer in the invention [(exemplified compounds (P-1) to (P-12)) will be shown below, but the invention is not limited to them.

Numerical values described in each structural unit of exemplified compounds represent a polymerization mole ratio of a copolymer.

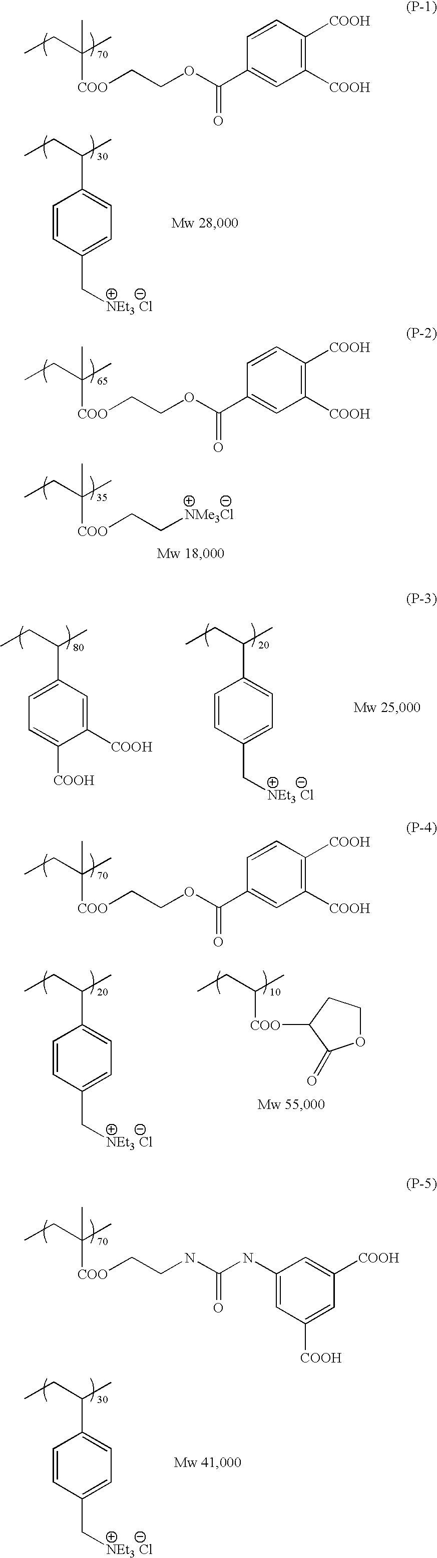

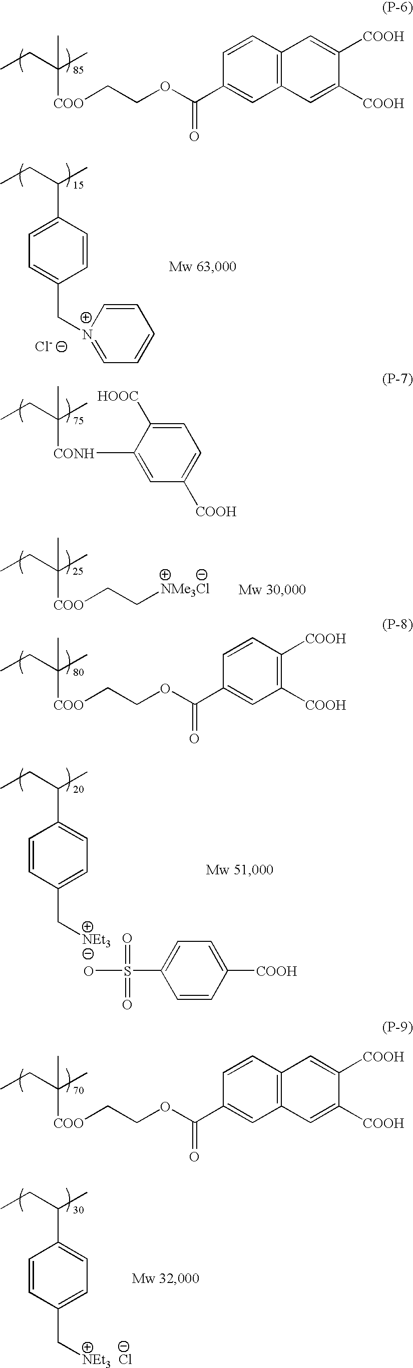

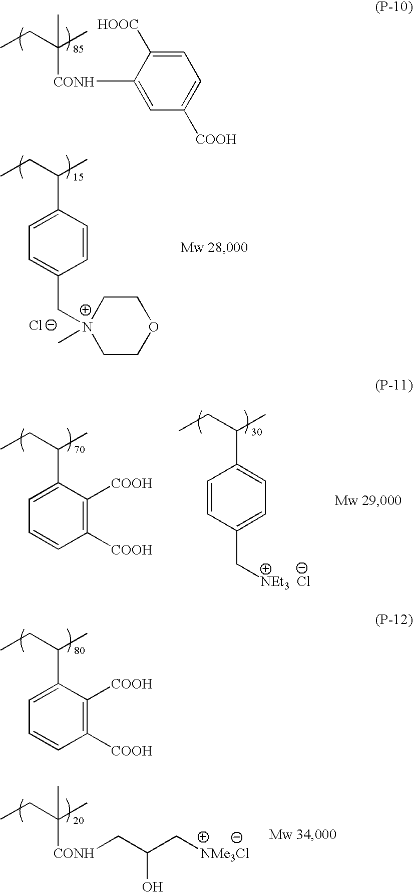

A content of the specified polymer in an intermediate layer is preferably 50 to 100 mass %, more preferably 80 to 100 mass % relative to a total solid matter constituting an intermediate layer.

The specified polymers of the invention may be used alone, or two or more kinds may be used by mixing them. Herein, use of two or more kinds of specified polymers by mixing them may be use of two or more kinds of specified polymers having different structures by mixing them, or use of two or more kinds of specified polymers having the same structure but having different molecular weights by mixing them.

(Formation of Intermediate Layer)

An intermediate layer in the invention can be provided by coating a coating solution in which respective components of the aforementioned intermediate layer are dissolved (coating solution for forming intermediate layer) on a support described later by a variety of methods. A method of coating an intermediate layer is not particularly limited, but representative methods are as follows.

That is, examples include (1) a coating method of coating, on a support, a solution in which a specified polymer in the invention is dissolved in an organic solvent such as methanol, ethanol and methyl ethyl ketone, or a mixed solvent of them, or a mixed solvent of these organic solvents and water, and drying this, and (2) a coating method of immersing a support in a solution in which a specified polymer in the invention is dissolved in an organic solvent such as methanol, ethanol and methyl ethyl ketone, or a mixed solvent of them, or a mixed solvent of these organic solvents and water, thereafter, washing this with water or the air, and drying to provide an intermediate layer.

In the (1) coating method, a solution having a concentration of a total of the aforementioned compounds of 0.005 to 10 mass % may be coated by various methods. As a coating means, any means such as bar coater coating, rotation coating, spray coating, and curtain coating may be used. In addition, in the (2) coating method, a concentration of a solution is 0.005 to 20 mass %, preferably 0.01% to 10 mass %, an immersing temperature is 0° C. to 70° C., preferably 5 to 60° C., and an immersing time is 0.1 second to 5 minutes, preferably 0.5 second to 120 seconds.

The coating solution for forming an intermediate layer may be used in a range of a pH=0 to 12, more preferably pH=0 to 6, by adjusting a pH with basic substances such as ammonia, triethylamine, and potassium hydroxide, inorganic acids such as hydrochloric acid, phosphoric acid, sulfuric acid and nitric acid, various organic acidic substances such as organic sulfonic acid such as nitrobenzenesulfonic acid and naphthalenesulfonic acid, organic phosphonic acid such as phenylphosphonic acid, and organic carboxylic acid such as benzoic acid, fumaric acid and malic acid, or organic chloride such as naphthalenesulfonyl chloride, and benzenesulfonyl chloride.

In addition, for improving tone reproductivity of a planographic printing plate, a substance absorbing ultraviolet light, visible light or infrared light may be added to the coating solution for forming an intermediate layer.

A covering amount of an intermediate layer in the invention after drying is suitably 1 to 100 mg/m², preferably 2 to 70 mg/m² expressed by a total amount.

[Recording Layer]

An infrared-ray laser photosensitive positive-type recording layer (hereinafter, conveniently, simply referred to as “recording layer”) in the invention will be explained. It is preferable that a recording layer in the invention is constructed by containing (A) an alkali-soluble resin, (B) an infrared-ray absorbing agent and, if necessary, (C) other component.

Respective components contained in a recording layer will be sequentially explained below.

[(A) Alkali-Soluble Resin]

It is preferable that a recording layer in the invention contains an alkali-soluble resin. The alkali-soluble resin includes homopolymers containing an acidic group on a main chain and/or a side chain in a polymer, copolymers of them, and a mixture thereof.

Inter alia, resins having an acidic group listed in the following (1) to (6) on a main chain and/or a side chain of a polymer are preferable from a viewpoint of solubility in an alkaline developer, and manifestation of the dissolution suppressing ability.

(1) Phenol group (—Ar—OH)

(2) Sulfonamide group (—SO₂NH—R)

(3) Substituted sulfonamide-based acid group (hereinafter, referred to as “active imido group”)
[—SO₂NHCOR, —SO₂NHSO₂R, —CONHSO₂R]
(4) Carboxylic acid group (—CO₂H)
(5) Sulfonic acid group (—SO₃H) (6) Phosphoric acid group (—OPO₃H₂)

In the (1) to (6), Ar represents a divalent aryl tethering group optionally having a substituent, and R represents a hydrogen atom or a hydrocarbon group optionally having a substituent.

Among alkali-soluble resins having an acidic group selected from the (1) to (6), an alkali-soluble resin having (1) a phenol group, (2) a sulfonamido group or (3) an active imido group is preferable and, particularly, an alkali-soluble resin having (1) a phenol group or (2) a sufonamido group is most preferable from a viewpoint of sufficiently maintaining solubility in an alkaline developer, developing latitude, and film strength.

As the alkali-soluble resin comprising the acidic group selected from the above-mentioned (1) to (6), the following can be exemplified.

(1) Examples of the alkali-soluble resin comprising phenol group may include novolak resin such as condensation polymers of phenol and formaldehyde; condensation polymers of m-cresol and formaldehyde, condensation polymers of p-cresol and formaldehyde, condensation polymers of m-/p-mixed cresol and formaldehyde, and condensation polymers of phenol, cresol (m-, p-, or m-/p-mixture) and formaldehyde; and condensation copolymers of pyrogallol and acetone.

Further, copolymers obtained by copolymerizing compounds comprising phenyl groups can be exemplified. Examples of the compounds having phenol group include acrylamide, methacrylamide, acrylic acid ester, methacrylic acid ester, or hydroxystyrene.

(2) Examples of the alkali-soluble resin comprising sulfoneamido group may include polymers obtained by using the minimum component units derived from compounds comprising sulfoneamido group as main constituent components. Examples of such compounds include those having at least one sulfoneamido group comprising at least one hydrogen atom bonded to the nitrogen atom and at least one polymerizable unsaturated group, in the molecules. Among them, low molecular weight compounds comprising acryloyl, allyl, or vinyloxy group as well as substituted or mono-substituted aminosulfonyl group or a substituted sulfonylimino group in molecules are preferable and the following compounds defined by the following (i) to (v) can be exemplified.

Examples thereof include compounds represented by any one of the following general formulae (i) to (v):

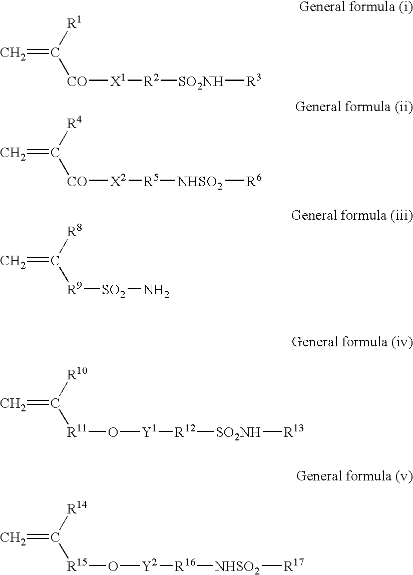

In the general formulae (i) to (v), X¹ and X² each independently represent —O—, or —NR⁷—; R¹ and R⁴ each independently represent a hydrogen atom, or —CH₃; R², R⁵, R⁹, R¹² and R¹⁶ each independently represent an alkylene, cycloalkylene, arylene or aralkylene group which may have a substituent and has 1 to 12 carbon atoms; R³, R⁷ and R¹³ each independently represent a hydrogen atom, or an alkyl, cycloalkyl, aryl or aralkyl group which may have a substituent and has 1 to 12 carbon atoms; R⁶ and R¹⁷ each independently represent an alkyl, cycloalkyl, aryl or aralkyl group which may have a substituent and has 1 to 12 carbon atoms; R⁸, R¹⁰ and R¹⁴ each independently represent a hydrogen atom or —CH₃; R¹¹ and R¹⁵ each independently represent a single bond, or an alkylene, cycloalkylene, arylene or aralkylene group which may have a substituent and has 1 to 12 carbon atoms; and Y¹ and Y² each independently represent a single bond or —CO—.

Of the compounds represented by the represented by the general formulae (i) to (v), in particular, the following can preferably be used in the invention: m-aminosulfonylphenyl methacrylate, N-(p-aminosulfonylphenyl)methacrylamide and N-(p-aminosulfonylphenyl)acrylamide.

(3) Examples of the monomer having an active imide group in the item (3) include compounds each having in the molecule thereof one or more active imide groups represented by the above-mentioned structural formula and one or more unsaturated groups which can be polymerized with the active imide group(s). Of these compounds, preferable are compounds each having in the molecule thereof one or more active imide groups represented by the following structural formula and one or more unsaturated groups which can be polymerized with the active imide group(s):

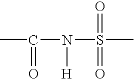

Specifically, N-(p-toluenesulfonyl)methacrylamide, N-(p-toluenesulfonyl)acrylamide and others can be preferably used.

(4) Examples of the monomer having a carboxylic acid group in the item (4) include compounds each having in the molecule thereof one or more carboxylic acid groups and one or more unsaturated groups which can be polymerized with the carboxylic acid group(s).

(5) Examples of the monomer having a sulfonic acid group in the item (5) include compounds each having in the molecule thereof one or more sulfonic acid groups and one or more unsaturated groups which can be polymerized with the sulfonic acid group(s).

(6) Examples of the monomer having a phosphoric acid group in the item (6) include compounds each having in the molecule thereof one or more phosphoric acid group and one or more unsaturated groups which can be polymerized with the phophoric acid group(s).

The minimum constituent unit comprising acidic group selected from (1) to (6) composing an alkali-soluble resin to be used for the image recording layer of the invention is not necessarily limited to one particular unit, but those obtained by copolymerizing two or more minimum constituent units comprising the same acidic group or two or more minimum constituent units comprising different acidic groups can also be used.

The above-mentioned copolymer contains the compound having the acidic group selected from (1) to (6) to be copolymerized in an amount preferably 10% by mole or more, more preferably 20% by mole or more. If it is less than 10% by mole, the development latitude tends to be improved insufficiently.

In the invention, in the case the compounds are copolymerized to use the obtained copolymer as the alkali-soluble resin, the compounds to be copolymerized may include other compounds without acidic group (1) to (6). Examples of the compounds without acidic group (1) to (6) include the following compounds (m1) to (m12), however they should not be limited to these examples. They are also useful for the copolymer components of the component (C).

(m1) Acrylic acid esters and methacrylic acid esters having aliphatic hydroxyl groups such as 2-hydroxyethyl acrylate or 2-hydroxyethyl methacrylate.

(m2) Alkyl acrylate such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.

(m3) Alkyl methacrylate such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate, and glycidyl methacrylate.

(m4) Acrylamide or methacrylamide such as acrylamide, methacrylamide, N-methylol acrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacxrylamide.

(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.

(m6) Vinyl esters such as vinyl acetate, vinyl chloroacetate, vinyl butylate, and vinyl benzoate.

(m7) Styrenes such as styrene, α-methylstyrene, methylstyrene, and chloromethylstyrene.

(m8) Vinyl ketones such as methyl vinyl ketone, ethyl vinyl ketone, propyl vinyl ketone, and phenyl vinyl ketone.

(m9) Olefins such as ethylene, propylene, isobutylene, butadiene, and isoprene.

(m10)N-vinylpyrrolidone, acrylonitrile, and methacrylonitrile.

(m11) Unsaturated imides such as maleimide, N-acryloylacrylamide, N-acetylmethacrylamide, N-propionylmethacrylamide, and N-(p-chlorobenzoyl)methacrylamide.

(m12) Unsaturated carboxylic acid such as acrylic acid, methacrylic acid, maleic anhydride, and itaconic acid.

As an alkali-soluble resin, since image forming property is improved from a viewpoint that strong hydrogen binding property is caused at an unexposed part, and a part of hydrogen bonds are easily eliminated at an exposed part, and that a difference in developability between an unexposed part and an exposed part for a non-silicate developer is great, an alkali-soluble resin having a phenolic hydroxy group is preferable, and preferable examples include a novolak resin such as a phenol formaldehyde resin, a m-cresol formaldehyde resin, a p-cresol formaldehyde resin, a m-/p-mixed cresol formaldehyde resin, and a phenol/cresol (any of m-, p-, and m-/p-mixed may be used) mixed formaldehyde resin, and a pyrogallolacetone resin. Inter alia, particularly preferable is a novolak resin.

Also, as the alkali-soluble resin having phenolic hydroxyl groups, condensed copolymers of phenol and formaldehyde comprising alkyl having 3 to 8 carbon atoms such as tert-butylphenol formaldehyde resin and octylphenol formaldehyde resin as a substituent group can be exemplified as described in U.S. Pat. No. 4,123,279.

The alkali-soluble resin has a weight average molecular weight preferably 500 or higher and more preferably 1,000 to 700,000 in terms of the image formability and has a number average molecular weight preferably 500 or higher and more preferably 700 to 650,000. The dispersion (the weight average molecular weight/the number average molecular weight) is preferably 1.1 to 10.

These alkali-soluble resins are used alone and two or more of them may be used in combination. In the case of combination, as described in U.S. Pat. No. 4,123,279, condensed polymers of phenol comprising alkyl having 3 to 8 carbon atoms as a substituent group and formaldehyde such as condensed polymer of t-butylphenol and formaldehyde and condensed polymer of octyl phenol and formaldehyde, and as described in Japanese Patent Application Laid-Open No. 2000-241972 previously applied by inventors, alkali-soluble resins having phenol structure having electron attractive group in an aromatic ring may be used in combination.

The total content of the alkali-soluble resins of the invention, in the upper layer, is preferably 30 to 98% by weight and more preferably 40 to 95% by weight in total solid components of the upper layer. It is preferable because the durability, the sensitivity, and the image formability are all excellent in the above-mentioned range.

[(B) Infrared-Ray Absorbing Agent]

It is preferable that a recording layer in the invention contains (B) an infrared-ray absorbing agent. The infrared-ray absorbing agent can be used without limitation in an absorption wavelength region as far as it is a substance which absorbs a light energy irradiation ray, and generates heat. From a viewpoint that suitability in an easily available high output laser, preferable examples include an infrared-ray absorbing dye and pigment having an absorption maximum at a wavelength of 760 nm to 1200 nm.

The infrared-absorbing dyes may be commercially available ones and known ones described in publications such as “Dye Handbook” (edited by the Society of Synthesis Organic Chemistry, Japan, and published in 1970). Specific examples thereof include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium dyes, metal thiolate complexes, oxonol dyes, diimonium dyes, aminium dyes, and croconium dyes.

Preferable examples of the dye include cyanine dyes described in JP-A Nos. 58-125246, 59-84356, 59-202829, and 60-78787; methine dyes described in JP-A Nos. 58-173696, 58-181690, and 58-194595; naphthoquinone dyes described in JP-A Nos. 58-112793, 58-224793, 59-48187, 59-73996, 60-52940, and 60-63744; squarylium dyes described in JP-A No. 58-112792; and cyanine dyes described in GB Patent No. 434,875.

Other preferable examples of the dye include near infrared absorbing sensitizers described in U.S. Pat. No. 5,156,938; substituted arylbenzo(thio)pyrylium salts described in U.S. Pat. No. 3,881,924; trimethinethiapyrylium salts described in JP-A No. 57-142645 (U.S. Pat. No. 4,327,169); pyrylium type compounds described in JP-A Nos. 58-181051, 58-220143, 59-41363, 59-84248, 59-84249, 59-146063, and 59-146061; cyanine dyes described in JP-A No. 59-216146; pentamethinethiopyrylium salts described in U.S. Pat. No. 4,283,475; and pyrylium compounds described in Japanese Patent Application Publication (JP-B) Nos. 5-13514 and 5-19702.

Additional preferable examples of the dye include near infrared absorbing dyes represented by formulae (I) and (II) as described in U.S. Pat. No. 4,756,993.

Among these dyes, particularly preferable are cyanine dyes, phthalocyanine dyes, oxonol dyes, squarylium dyes, pyrylium salts, thiopyrylium dyes, and nickel thiolate complexes. Dyes represented by the following general formulae (a) to (e) are also preferable since such dyes are excellent in terms of photothermal conversion efficiency. The cyanine dyes represented by the following general formula (a) are most preferable for the following reason: when the dyes are used in the photosensitive composition of the invention, the dyes manifest a high degree of interaction with the alkali-soluble resin, and the dyes are also excellent in terms of stability and economy.

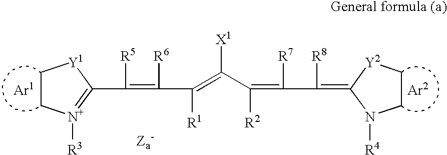

In general formula (a), X¹ represents a hydrogen atom, a halogen atom, —NPh₂, X²-L¹ (wherein X² represents an oxygen atom or a sulfur atom, L¹ represents a hydrocarbon group having 1 to 12 carbon atoms, an aromatic cyclic group having a heteroatom, or a hydrocarbon group containing a heteroatom and having 1 to 12 carbon atoms, and the heteroatom referred to herein is N, S, O, a halogen atom, or Se), or a group represented by the following:

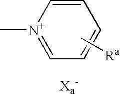

wherein Xa⁻ has the same definition as Za⁻, which will be described at a later time, and R^{a} represents a substituent selected from a hydrogen atom, an alkyl group, an aryl group, a substituted or unsubstituted amino group, or a halogen atom;

R¹ and R² each independently represents a hydrocarbon group having 1 to 12 carbon atoms, and from the viewpoint of the storage stability of the photosensitive composition of the invention when it is used in a coating solution for forming a recording layer of a planographic printing plate precursor, it is preferable that R¹ and R² each independently represents a hydrocarbon group having 2 or more carbon atoms, and more preferably R¹ and R² are bonded to each other to form a 5-membered or 6-membered ring.

Ar¹ and Ar², which may be the same or different, each represent an aromatic hydrocarbon group which may have a substituent. Preferable examples of the aromatic hydrocarbon group include benzene and naphthalene rings. Preferable examples of the substituent include hydrocarbon groups having 12 or less carbon atoms, halogen atoms, and alkoxy groups having 12 or less carbon atoms.

Y¹ and Y², which may be the same or different, each represents a sulfur atom, or a dialkylmethylene group having 12 or less carbon atoms.

R³ and R⁴, which may be the same or different, each represents a hydrocarbon group which has 20 or less carbon atoms and may have a substituent. Preferable examples of the substituent include alkoxy groups having 12 or less carbon atoms, a carboxyl group, and a sulfo group. R⁵, R⁶, R⁷ and R⁸, which may be the same or different, each represents a hydrogen atom, or a hydrocarbon group having 12 or less carbon atoms, and since the raw materials thereof can easily be obtained, each preferably represents a hydrogen atom.

In addition, Za⁻ represents a counteranion. However, when a cyanine pigment represented by the formula (a) has an anionic substituent in its structure, and neutralization of a charge is not necessary, Za⁻ is not necessary. Preferable Za⁻ is a halogen ion, a perchloric ion, tetrafluoroborate ion, a hexafluorophosphate ion, a carboxylic acid ion, and a sulfonic acid ion from a viewpoint of storage stability of a recording layer coating solution. From a viewpoint of compatibility with an alkali-soluble resin, and solubility in a coating solution, a halogen ion, and an organic acid ion such as a carboxylic acid ion and a sulfonic acid ion is preferable, a sulfonic acid ion is more preferable and, inter alia, an arylsulfonic acid ion is particularly preferable.

Specific examples of the cyanine dye represented by general formula (a), and which can be preferably used in the invention, include dyes in JP-A No. 2001-133969 (paragraphs [0017] to [0019]), JP-A No. 2002-40638 (paragraphs [0012] to [0038]), and JP-A No. 2002-23360 (paragraphs [0012] to [0023]), as well as dyes illustrated below.

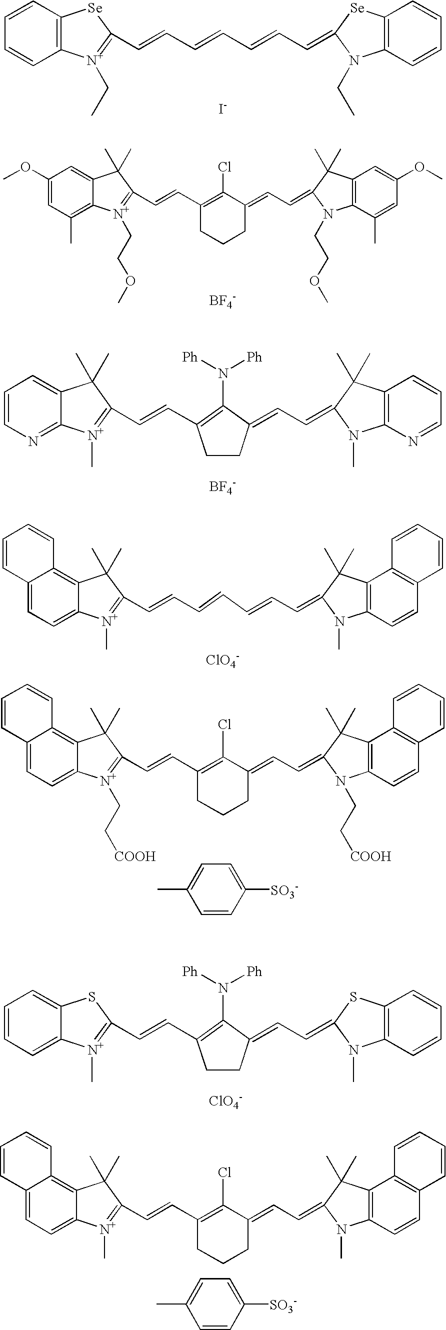

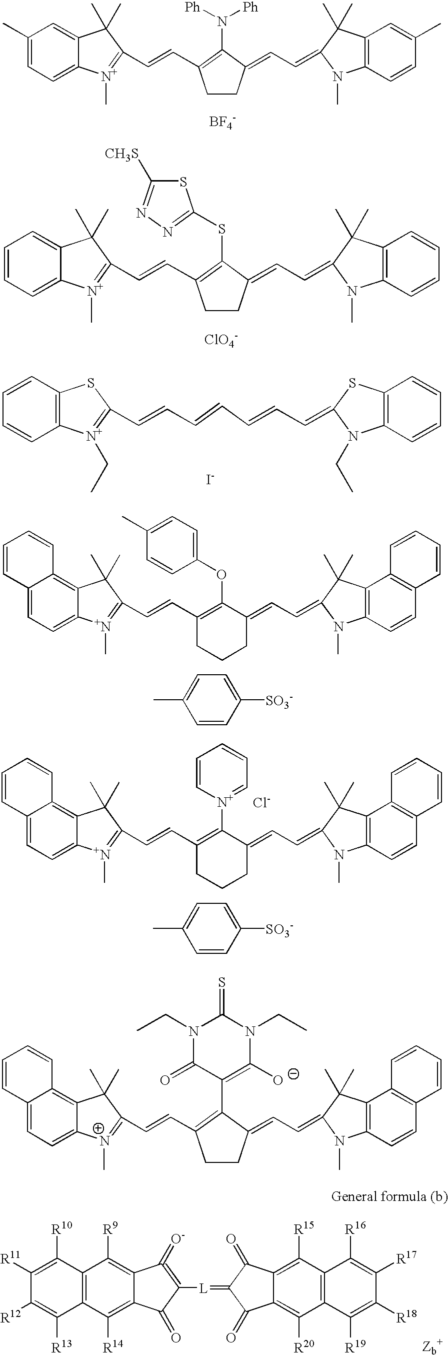

In the general formula (b), L represents a methine chain having 7 or more conjugated carbon atoms, and the methine chain may have one or more substituent. The substituents may be bonded to each other to form a cyclic structure. Zb⁺ represents a counter cation. Preferable examples of the counter cation include ammonium, iodonium, sulfonium, phosphonium and pyridinium ions, and alkali metal cations (such as Ni⁺, K⁺ and Li⁺).

R⁹ to R¹⁴ and R¹⁵ to R²⁰ each independently represents a substituent selected from hydrogen atom, halogen atom, and cyano, alkyl, aryl, alkenyl, alkynyl, carbonyl, thio, sulfonyl, sulfinyl, oxy and amino groups; or a substituent obtained by combining two or three from among these substituents. Two or three out of R⁹ to R¹⁴ and R¹⁵ to R²⁰ may be bonded to each other to form a cyclic structure.

A dye wherein L in general formula (b) represents a methine chain having 7 conjugated carbon atoms, and each of R⁹ to R¹⁴ and R¹⁵ to R²⁰ represents a hydrogen atom, is preferable since such a dye can be easily obtained and exhibits advantageous effects.

Specific examples of the dye represented by general formula (b), and which can be preferably used in the invention, are illustrated below.

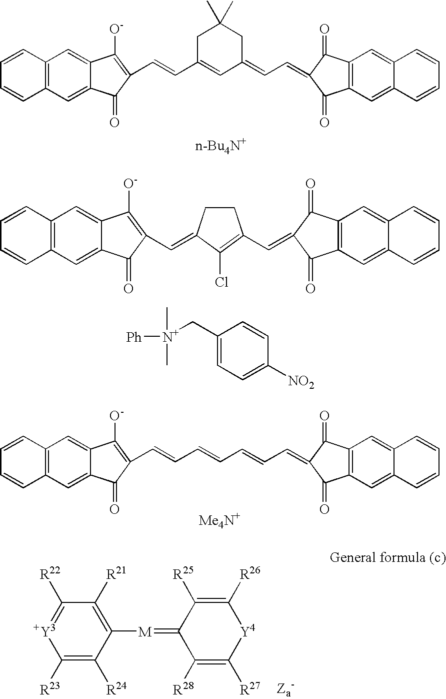

In general formula (c), Y³ and Y⁴ each independently represent an oxygen, sulfur, selenium or tellurium atom; M represents a methine chain having 5 or more conjugated carbon atoms; R²¹ to R²⁴ and R²⁵ to R²⁸, which may be the same or different, each represents a hydrogen or halogen atom, or a cyano, alkyl, aryl, alkenyl, alkynyl, carbonyl, thio, sulfonyl, sulfinyl, oxy or amino group; and Za⁻ represents a counter anion, and has the same meaning as Za⁻ in general formula (a).

Specific examples of the dye which is represented by general formula (c) and which can be preferably used in the invention, are illustrated below.

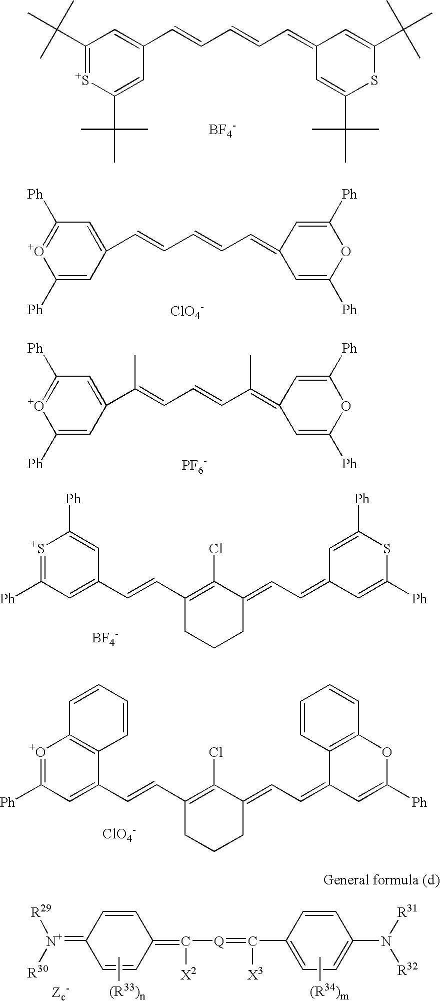

In general formula (d), R²⁹ to R³¹ each independently represents a hydrogen atom, an alkyl group or an aryl group; R³³ and R³⁴ each independently represents an alkyl group, a substituted oxy group, or a halogen atom; n and m each independently represents an integer of 0 to 4; and R²⁹ and R³⁰, or R³¹ and R³² may be bonded to each other to form a ring, or R²⁹ and/or R³⁰ may be bonded to R³³ to form a ring and R³¹ and/or R³² may be bonded to R³⁴ to form a ring. When plural R³³'s and R³⁴'s are present, R³³'s may be bonded to each other to form a ring, or R³⁴'s may be bonded to each other to form a ring.

X² and X³ each independently represents a hydrogen atom, an alkyl group or an aryl group, and at least one of X² and X³ represents a hydrogen atom or an alkyl group.

Q represents a trimethine group or a pentamethine group which may have a substituent, and may be combined with an bivalent linking group to form a cyclic structure. Zc⁻ represents a counter anion and has the same meanings as Za⁻ in general formula (a).

Specific examples of the dye represented by general formula (d) and which can be preferably used in the invention, are illustrated below.

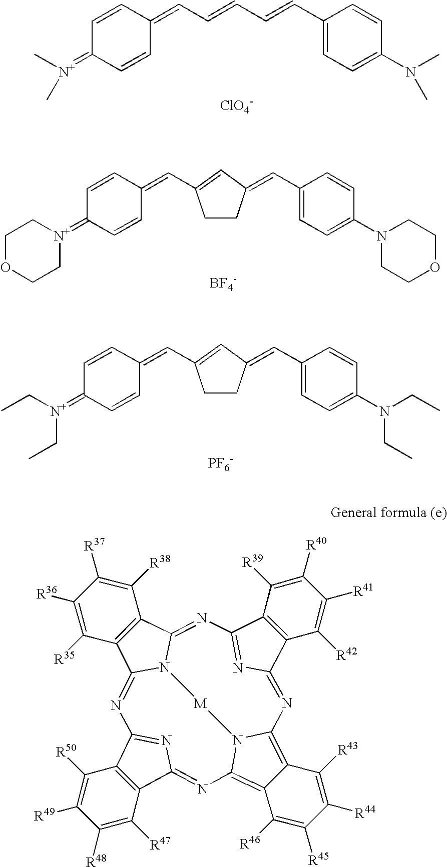

In general formula (e), R³⁵ to R⁵⁰ each independently represents a hydrogen or halogen atom, or a cyano, alkyl, aryl, alkenyl, alkynyl, hydroxyl, carbonyl, thio, sulfonyl, sulfinyl, oxy or amino group, or an onium salt structure, each of which may have a substituent; M represents two hydrogen atoms, a metal atom, a halo metal group, or an oxy metal group. Examples of the metal contained therein include atoms in IA, IIA, IIIB and IVB groups in the periodic table, transition metals in the first, second and third periods therein, and lanthanoid elements. Among these examples, preferable are copper, magnesium, iron, zinc, cobalt, aluminum, titanium, and vanadium.

Specific examples of the dye represented by general formula (e) and which can be preferably used in the invention, are illustrated below.

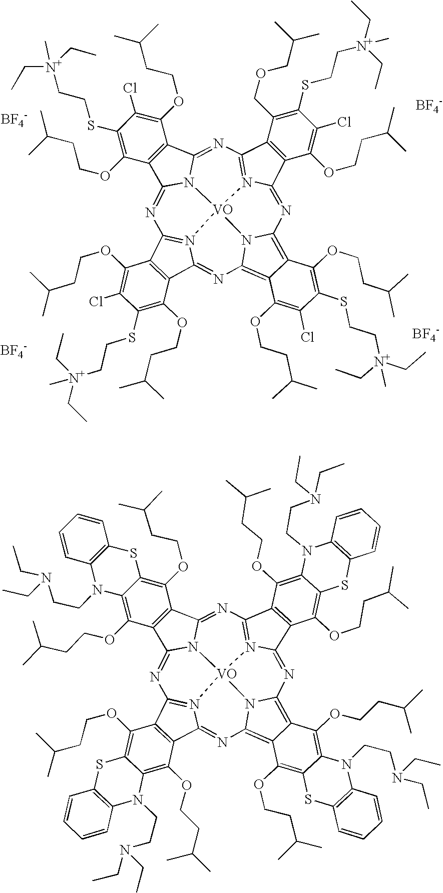

The pigment used as the infrared absorbent in the invention may be a commercially available pigment or a pigment described in publications such as Color Index (C.I.) Handbook, “Latest Pigment Handbook” (edited by Japan Pigment Technique Association, and published in 1977), “Latest Pigment Applied Technique” (by CMC Publishing Co., Ltd. in 1986), and “Printing Ink Technique” (by CMC Publishing Co., Ltd. in 1984).

Examples of the pigment include black pigments, yellow pigments, orange pigments, brown pigments, red pigments, purple pigments, blue pigments, green pigments, fluorescent pigments, metal powder pigments, and polymer-bonded dyes. Specifically, the following can be used: insoluble azo pigments, azo lake pigments, condensed azo pigments, chelate azo pigments, phthalocyanine pigments, anthraquinone pigments, perylene and perynone pigments, thioindigo pigments, quinacridone pigments, dioxazine pigments, isoindolinone pigments, quinophthalone pigments, dyeing lake pigments, azine pigments, nitroso pigments, nitro pigments, natural pigments, fluorescent pigments, inorganic pigments, and carbon black. Among these pigments, carbon black is preferable.

These pigments may be used with or without surface treatment. Examples of surface treatment include a method of coating the surface of the pigments with resin or wax; a method of adhering a surfactant onto the surface; and a method of bonding a reactive material (such as a silane coupling agent, an epoxy compound, or a polyisocyanate) to the pigment surface. The surface treatment methods are described in “Nature and Application of Metal Soap” (Saiwai Shobo), “Printing Ink Technique” (by CMC Publishing Co., Ltd. in 1984). And “Latest Pigment Applied Technique” (by CMC Publishing Co., Ltd. in 1986.

A particle diameter of a pigment is preferably in a range of 0.01 μm to 10 μm, further preferably in a range of 0.05 μm to 1 μm, particularly preferably in a range of 0.1 μm to 1 μm. When a particle diameter of a pigment is less than 0.01 μm, when a pigment dispersion is used in a coating solution for a recording layer of a planographic printing plate precursor, the pigment is not preferable in stability. On the other hand, when the particle diameter exceeds 10 μm, the particle is not preferable in uniformity of a recording layer.

The method for dispersing the pigment may be a known dispersing technique used to produce ink or toner. Examples of a dispersing machine, which can be used, include an ultrasonic disperser, a sand mill, an attriter, a pearl mill, a super mill, a ball mill, an impeller, a disperser, a KD mill, a colloid mill, a dynatron, a three-roll mill, and a pressing kneader. Details are described in “Latest Pigment Applied Technique” (by CMC Publishing Co., Ltd. in 1986).

These pigments or dyes is 0.01 to 50 mass %, preferably 0.1 to 10 mass % relative to a total solid matter constituting a recording layer. In the case of a dye, the dye can be added at a ratio of 0.5 to 10 mass % and, in the case of a pigment, the pigment can be added at a ratio of preferably 0.1 to 10 mass %. When an amount of a pigment or a dye to be added is less than 0.01 mass %, there is a tendency that a sensitivity is reduced. When the pigment or the dye is blended at an amount exceeding 50 mass %, there is a possibility that the blending adversely influences on uniformity of a recording layer, and durability of a recording layer as a blending amount is increased.

[(C) Other Component]

Further, if necessary, various additives as (C) other component can be added to a recording layer in the invention.

Examples of the additive include a dissolution suppressing agent shown below. In addition, particularly, when the (B) infrared-ray absorbing agent having no dissolution inhibiting ability is used, this dissolution suppressing agent can be an important component for maintaining alkali resistance of an image part.

It is preferable to use, as the dissolution suppressing agent, a substance which is thermally degrading, and substantially reduces solubility of an alkali-soluble resin in the not degraded state (degradability dissolution suppressing agent), such as an onium salt, an o-quinone diazide compound, and sulfonic acid alkyl ester.

As the decomposable and dissolution suppressing agent, preferable examples thereof include onium salts such as diazonium salts, iodonium salts, sulfonium salts, and ammonium salts and o-quinonediazido compounds. Among these examples, onium salts such as diazonium salts, iodonium salts and sulfonium salts are more preferable, and diazonium salts are especially preferable as the thermally decomposable and dissolution suppressing agent.

Preferable examples of the onium salt used in the invention include diazonium salts described in S. I. Schlesinger, Photogr. Sci. Eng., 18, 387 (1974), T. S. Bal et al., Polymer, 21, 423 (1980), and JP-A No. 5-158230; ammonium salts described in U.S. Pat. Nos. 4,069,055 and 4,069,056, and JP-A No. 3-140140; phosphonium salts described in D.C. Necker et al., Macromolecules, 17, 2468 (1984), C. S. Wen et al., Teh, Proc. Conf. Rad. Curing ASIA, p478 Tokyo, October (1988), and U.S. Pat. Nos. 4,069,055 and 4,069,056; iodonium salts described in J. V. Crivello et al., Macromolecules, 10 (6), 1307 (1977), Chem. & Eng. News, Nov. 28, p31 (1988), EP No. 104,143, U.S. Pat. Nos. 5,041,358 and 4,491,628, and JP-A Nos. 2-150848 and 2-296514; sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V. Crivello et al., J. Polymer Sci., Polymer Chem. Ed., 17, 2877 (1979), EP Nos. 370,693, 233,567, 297,443 and 297,442, U.S. Pat. Nos. 4,933,377, 3,902,114, 5,041,358, 4,491,628, 4,760,013, 4,734,444 and 2,833,827, and DE Patent Nos. 2,904,626, 3,604,580 and 3,604,581; selenonium salts described in J. V. Crivello et al., Macromolecules, 10 (6), 1307 (1977), J. V. Crivello et al., J. Polymer Sci., Polymer Chem. Ed., 17, 1047 (1979); arsonium salts described in C. S. Wen et al., and The Proc. Conf. Rad. Curing ASIA, p 478, Tokyo, October (1988).

Among such onium salts, diazonium salts are particularly preferable from the viewpoints of both their capacity of hindering dissolution, and their thermal decomposability. The diazonium salts represented by general formula (I) in the JP-A No. 5-158230 and the diazonium salts represented by general formula (1) in JP-A No. 11-143064 are more preferable, and diazonium salts represented by general formula (1) in the JP-A No. 11-143064, which have low absorption wavelength peaks within the visible ray range, are most preferable.

Examples of the counter ion of the onium salt include tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid, and p-toluenesulfonic acid. Among these examples, hexafluorophosphoric acid, and alkylaromatic sulfonic acids such as triisopropylnaphthalenesulfonic acid and 2,5-dimethylbezenesulfonic acid are particularly preferable.

The quinonediazide is preferably an o-quinonediazide compound. The o-quinonediazide compound used in the invention is a compound having at least one o-quinonediazide group and having an alkali-solubility increased by being thermally decomposed. The compound may be any one of compounds having various structures.

In other words, the o-quinonediazide compound assists the solubility of the photosensitive material both from the viewpoint of the effects of being thermally decomposed, and thereby losing the function of suppressing the dissolution of the binder, and the effect that the o-quinonediazide itself is changed into an alkali-soluble material.

Preferable examples of the o-quinonediazide compound used in the invention include compounds described in J. Coser, “Light-Sensitive Systems” (John Wiley & Sons. Inc.), pp. 339-352. Particularly preferable are sulfonic acid esters or sulfonamides of o-quinonediazide made to react with various aromatic polyhydroxy compounds or with aromatic amino compounds.

Further preferable examples include an ester made from benzoquinone-(1,2)-diazidesulfonic acid chloride or naphthoquinone-(1,2)-diazide-5-sulfonic acid chloride and pyrogallol-acetone resin, as described in JP-B No. 43-28403; and an ester made from benzoquinone-(1,2)-diazidesulfonic acid chloride or naphthoquinone-(1,2)-diazide-5-sulfonic acid chloride and phenol-formaldehyde resin, as described in U.S. Pat. No. 3,046,120 and U.S. Pat. No. 3,188,210.

Additional preferable examples include an ester made from naphthoquinone-(1,2)-diazide-4-sulfonic acid chloride and phenol-formaldehyde resin or cresol-formaldehyde resin; and an ester made from naphthoquinone-(1,2)-diazide-4-sulfonic acid chloride and pyrogallol-acetone resin.

Other useful o-quinonediazide compounds are reported in unexamined or examined patent documents, examples of which include JP-A Nos. 47-5303, 48-63802, 48-63803, 48-96575, 49-38701 and 48-13354, JP-B No. 41-11222, 45-9610 and 49-17481, U.S. Pat. Nos. 2,797,213, 3,454,400, 3,544,323, 3,573,917, 3,674,495 and 3,785,825, GB Patent Nos. 1,227,602, 1,251,345, 1,267,005, 1,329,888 and 1,330,932, and DE Patent No. 854,890.

When the photosensitive composition of the invention is used as a recording layer of a planographic printing plate precursor, the amount of onium salt and/or o-quinonediazide compound added as the decomposable dissolution suppresser(s) is preferably from 0.1 to 10%, more preferably from 0.1 to 5%, and even more preferably from 0.2 to 2% by relative to the total solid contents of the recording layer. The onium salts and the o-quinonediazide compounds may be used either independently or in the form of mixtures of two or more thereof.

The amount of additives other than the o-quinonediazide compound added is preferably from 0 to 5%, more preferably from 0 to 2%, and even more preferably from 0.1 to 1.5% by mass. The additives and the binder used in the invention are preferably incorporated into the same layer.

A dissolution suppresser having no decomposability may be used in combination. Preferable examples thereof include sulfonic acid esters, phosphoric acid esters, aromatic carboxylic acid esters, aromatic disulfones, carboxylic acid anhydrides, aromatic ketones, aromatic aldehydes, aromatic amines, and aromatic ethers, details of which are described in JP-A No. 10-268512; acidic color-developable dyes which have a lactone skeleton, an N,N-diarylamide skeleton or a diarylmethylimino skeleton and also function as a coloring agent, details of which are described in JP-A No. 11-190903; and nonionic surfactants described, details of which are described in JP-A No. 2000-105454.

In order to strengthen discrimination of images to be obtained (discrimination of hydrophobicity and hydrophilicity), or to improve the resistance of the surface against scratches, the following also may be used: a polymer containing, as a polymerization component, a (meth)acrylic monomer having in the 2 or 3 perfluoroalkyl groups having 3 to 20 carbon atoms. When the photosensitive composition of the invention is used as a recording layer of a planographic printing plate precursor, in relation to the total solid contents of the recording layer, the amount of this compound added is preferably from 0.1 to 10%, and more preferably from 0.5 to 5% by mass.

In order to provide the photosensitive composition of the invention with resistance against scaratches, a compound for lowering the static friction coefficient of the surface may be added to the composition. Specific examples thereof include long-chain alkyl carboxylic acid esters as described in U.S. Pat. No. 6,117,913. When the photosensitive composition of the invention is used as a recording layer of a planographic printing plate precursor, in relation to the total solid contents of the recording layer, the amount of such a compound added is preferably from 0.1 to 10%, and more preferably from 0.5 to 5% by mass.

The photosensitive composition of the invention may, whenever necessary, contain a compound having an acidic group of low-molecular weight. Examples of such an acidic group include sulfonic acid, carboxylic acid and phosphoric acid groups. Compounds having a sulfonic acid group are particularly preferable. Specific examples include aromatic sulfonic acids and aliphatic sulfonic acids such as p-toluenesulfonic acid and naphthalenesulfonic acid.

In order to enhance sensitivity, the photosensitive composition may also contain a cyclic acid anhydride, a phenolic compound, or an organic acid.

Examples of cyclic acid anhydride include phthalic anhydride, tetrahydrophthalic anhydride, hexahydrophthalic anhydride, 3,6-endooxy-Δ4-tetrahydrophthalic anhydride, tetrachlorophthalic anhydride, maleic anhydride, chloromaleic anhydride, α-phenylmaleic anhydride, succinic anhydride, and pyromellitic anhydride which are described in U.S. Pat. No. 4,115,128.

Examples of phenolic compound include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane.

Examples of the organic acid include sulfonic acids, sulfonic acids, alkylsulfuric acids, phosphonic acids, phosphates, and carboxylic acids, which are described in JP-A No. 60-88942 or 2-96755. Specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

When the cyclic acid anhydride, the phenol or the organic acid is added to a recording layer of a planographic printing plate precursor, the ratio thereof in the recording layer is preferably from 0.05 to 20%, more preferably from 0.1 to 15%, and even more preferably from 0.1 to 10% by mass.

When the photosensitive composition according to the invention is used in a recording layer coating solution for a planographic printing plate precursor, in order to enhance stability in processes which affect conditions of developing, the following can be added: nonionic surfactants as described in JP-A Nos. 62-251740 and 3-208514; amphoteric surfactants as described in JP-A Nos. 59-121044 and 4-13149; siloxane compounds as described in EP No. 950517; and copolymers made from a fluorine-containing monomer as described in JP-A No. 11-288093.

Specific examples of nonionic surfactants include sorbitan tristearate, sorbitan monopalmitate, sorbitan trioleate, monoglyceride stearate, and polyoxyethylene nonyl phenyl ether. Specific examples of amphoteric surfactants include alkyldi(aminoethyl)glycine, alkylpolyaminoethylglycine hydrochloride, 2-alkyl-N-carboxyethyl-N-hydroxyethylimidazolinium betaine and N-tetradecyl-N,N′-betaine type surfactants (trade name: “Amolgen K”, manufactured by Dai-ichi Kogyo Seiyaku Co., Ltd.).

The siloxane compounds are preferably block copolymers made from dimethylsiloxane and polyalkylene oxide. Specific examples thereof include polyalkylene oxide modified silicones (trade names: DBE-224, DBE-621, DBE-712, DBE-732, and DBE-534, manufactured by Chisso Corporation; trade name: Tego Glide 100, manufactured by Tego Co., Ltd.).

The content of the nonionic surfactant and/or the amphoteric surfactant in the present recording layer is preferably from 0.05 to 15% by mass, and more preferably from 0.1 to 5% by mass.

To the recording layer of the invention may be added a printing-out agent for obtaining a visible image immediately after the photosensitive composition of the invention has been heated by exposure to light, or a dye or pigment as an image coloring agent.

A typical example of a printing-out agent is a combination of a compound which is heated by exposure to light, thereby emitting an acid (an optically acid-generating agent), and an organic dye which can form salts (salt formable organic dye).

Specific examples thereof include combinations of an o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in each of JP-A Nos. 53-36223, 54-74728, 60-3626, 61-143748, 61-151644 and 63-58440.

The trihalomethyl compound is classified into an oxazol compound or a triazine compound. Both of the compounds provide excellent in stability over the passage of time and produce a vivid printed-out image.

As the image coloring agent, a dye different from the above-mentioned salt-formable organic dye may be used. Preferable examples of such a dye, and of the salt-formable organic dye, include oil-soluble dyes and basic dyes.

Specific examples thereof include Oil yellow #101, Oil Yellow #103, Oil Pink #312, Oil Green BG, Oil Blue BOS, Oil Blue #603, Oil Black BY, Oil Black BS, and Oil Black T-505 (each of which is manufactured by Orient Chemical Industries Ltd.); Victoria Pure Blue, Crystal Violet (CI42555), Methyl Violet (CI42535), Ethyl Violet, Rhodamine B (CI 145170B), Malachite Green (CI42000), and Methylene Blue (CI52015).

Dyes described in JP-A No. 62-293247 are particularly preferable. These dyes may be added to the photosensitive composition at a ratio of 0.01 to 10% by mass, and preferably 0.1 to 3% by mass, relative to the total solid contents therein.

Whenever necessary, a plasticizer may be added to the photosensitive composition of the invention to give flexibility to a coating film made from the composition. Examples of the plasticizer include oligomers and polymers of butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl olete, and acrylic acid and methacrylic acid.

In addition to the above, the following may be appropriately added to the composition, depending on the objective: an epoxy compound; a vinyl ether; a phenol compound having a hydroxymethyl group and a phenol compound having an alkoxymethyl group, described in JP-A No. 8-276558; and a cross-linkable compound having an effect of suppressing dissolution in an alkali, described in JP-A No. 11-160860, and which was previously proposed by the present inventors.

[Formation of Recording Layer]

A recording layer in the invention can be formed by dissolving respective components constituting the recording layer in a solvent, and coating the solution on the aforementioned intermediate layer.

The solvent to be used here may include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfurane, γ-butyrolactone, and toluene, but the solvent is not limited to these examples. These solvents may be used alone or in form of mixture.

The concentration of the above-mentioned components (the total solid content including the additives) in the solvent is preferably 1 to 50% by weight.

In general, the coated amount (the solid content) of the photosensitive layer after being coated and dried is preferably 0.5 to 5.0 g/m² for the planographic printing plate precursor, although the amount may vary depending on the applications. The smaller the coating amount, the larger the apparent sensitivity but results in the poorer coating properties of the photosensitive film.

As the method for coating, a various kinds of methods can be employed. Examples thereof include bar coater coating, rotation coating, spray coating, curtain coating, dip coating, air knife coating, blade coating, and roll coating.

A surfactant for improving coating property, for example, a fluorine-based surfactant described in JP-A No. 62-170950 can be added to a recording layer coating solution in the invention. A preferable addition amount is 0.01 to 1 mass %, further preferably 0.05 to 0.5 mass % in a total solid matter in a recording layer.

[Construction of Recording Layer]

A recording layer in the invention may take a layered structure, for example, a bilayered structure in which a resin layer consisting of an alkali-soluble polymer as a lower layer (support side) and the aforementioned recording layer as an upper layer are provided.

Thereby, by providing a recording layer (upper layer) in which solubility in an alkali developer is reduced by light exposure, on an exposure surface or in a vicinity thereof, a sensitivity for an infrared-ray laser becomes better and, by a resin layer (lower layer) which is present between a support and the recording layer and functions as a heat-insulating layer, heat generated by exposure to an infrared-ray laser is not diffused into a support, and effective use can be done, thus, a sensitivity is increased.

In addition, it is thought that since a recording layer (upper layer) which becomes non-permeable to an alkali developer functions as a protective layer for this resin layer (lower layer) at an exposed part, developing stability becomes better and, at the same time, an image excellent in discrimination is formed, and stability with time is retained. Further, it is thought that since, at an unexposed part, an uncured binder component is rapidly dissolved and dispersed in a developer and, further, this resin layer (lower layer) present adjacent to a support consists of an alkali-soluble polymer, solubility in a developer is better and, for example, since even when a developer having reduced activity is used, the layer is rapidly dissolved without generating a remaining film, developability is excellent.

[Support]

The support used in the planographic printing plate precursor is a plate having dimensional stability. A plate satisfying required physical properties such as strength and flexibility can be used without any restriction. Examples thereof include paper, plastic (such as polyethylene, polypropylene or polystyrene)-laminated papers, metal plates (such as aluminum, zinc and copper plates), plastic films (such as cellulose biacetate, cellulose triacetate, cellulose propionate, cellulose lactate, cellulose acetate lactate, cellulose nitrate, polyethylene terephthalate, polyethylene, polystyrene, polypropylene, polycarbonate, and polyvinyl acetate films), and papers or plastic films on which, as described above, a metal is laminated or vapor-deposited.

The support is preferably a polyester film or an aluminum plate, and more preferably an aluminum plate, since an aluminum plate is superior in terms of dimensional stability and is also relatively inexpensive.

Preferable examples of the aluminum plate include a pure aluminum plate and alloy plates made of aluminum as a main component with a very small amount of other elements. A plastic film on which aluminum is laminated or vapor-deposited may also be used.

Examples of other elements contained in the aluminum alloys include silicon, iron, manganese, copper, magnesium, chromium, zinc, bismuth, nickel, and titanium. The content by percentage of different elements in the alloy is at most 10% by mass. A particularly preferable aluminum plate in the invention is a pure aluminum plate; however, since from the viewpoint of refining a completely pure aluminum cannot be easily produced, a very small amount of other elements may also be contained in the plate.

The aluminum plate used as the support is not specified in terms of the composition thereof. Thus, aluminum plates which are conventionally known can be appropriately used. The thickness of the aluminum plate used in the invention is from about 0.1 to 0.6 mm, preferably from 0.15 to 0.4 mm, and more preferably from 0.2 to 0.3 mm.

If necessary, prior to the surface-roughening treatment, the aluminum plate may optionally be subjected to degreasing treatment, in order to remove rolling oil or the like on the surface, with a surfactant, an organic solvent, an aqueous alkaline solution or the like.

The surface-roughening treatment of the aluminum surface can be performed by various methods such as a mechanical surface-roughening method, a method of dissolving and roughening the surface electrochemically, and a method of dissolving the surface selectively in a chemical manner.

Mechanical surface-roughening methods which can be used may be known methods, such as a ball polishing method, a brush polishing method, a blast polishing method or a buff polishing method. An electrochemical surface-roughening method may be a method of performing surface-roughening in an electrolyte of hydrochloric acid or nitric acid, by use of an alternating current or a direct current. As disclosed in JP-A No. 54-63902, a combination of the two kinds of methods may be used.

An aluminum plate whose surface is roughened as described above is if necessary subjected to alkali-etching treatment and neutralizing treatment. Thereafter, an anodizing treatment is optionally applied in order to improve the water holding capacity and wear resistance of the surface.

The electrolyte used in the anodizing treatment of the aluminum plate is any one selected from various electrolytes which can form a porous oxide film. Among which in general use are electrolytes of sulfuric acid, phosphoric acid, oxalic acid, chromic acid, or a mixed acid thereof. The concentration of the electrolyte may be appropriately decided depending on the kind of electrolyte selected.

Treatment conditions for anodization cannot be specified as a general rule since conditions vary depending on the electrolyte used; however, the following range of conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of anodic oxide film is less than 1.0 g/m², printing resistance is inadequate or non-image portions of the planographic printing plate tend to become easily damaged and the so-called “blemish stains”, resulting from ink adhering to damaged portions at the time of printing, are easily generated.

After the anodizing treatment, the surface of the aluminum is if necessary subjected to treatment for obtaining hydrophilicity. This securance of hydrophilicity treatment may be an alkali metal silicate (for example, an aqueous sodium silicate solution) method, as disclosed in U.S. Pat. Nos. 2,714,066, 3,181,461, 3,280,734, and 3,902,734. In this method, the support is subjected to an immersing treatment or an electrolyzing treatment with an aqueous sodium silicate solution.

In addition, the following methods may also be used: a method of treating the support with potassium fluorozirconate, as disclosed in JP-B No. 36-22063, or with polyvinyl phosphonic acid, as disclosed in U.S. Pat. Nos. 3,276,868, 4,153,461, and 4,689,272.

As particularly preferable support treatment, it is preferable that an aluminum plate is sequentially subjected to mechanical surface roughening treatment, alkali etching treatment, desmut treatment with an acid, electrochemical surface roughening treatment using an electrolysis solution containing nitric acid, and electrochemical surface roughening treatment using an aqueous solution containing hydrochloric acid. A support which has undergone such the treatment has a very high surface area.

The reason why an intermediate layer in the invention manifests the more preferable effect in a support which has undergone the aforementioned treatment is not clear, but it is thought that since an intermediate layer in the invention can sufficiently cover a support surface due to the effect of interacting with a surface of a support having a very high surface area, durability between a recording layer and a support is further improved, and better non-image part staining properties can be also realized.

The planographic printing plate precursor of the invention can be converted into a planographic plate by various treating methods depending on a recording layer, and it is preferable to convert into a planographic printing plate by a method of performing developing using a developer containing substantially no alkali metal silicate salt, as described later. That is, it is preferable that the planographic printing plate precursor of the invention is a planographic printing plate precursor for being treated with a developer containing substantially no alkali metal silicate salt. Details of the present method are described in JP-A No. 11-109637 and, in the invention, the contents described in that gazette can be used.

[Plate-Making]

The positive-type planographic printing plate precursor manufactured as described above is usually subjected to image light exposure and developing treatment.

As a light source for light used in image exposure, a light source having an emitting wavelength in a near infrared to infrared region is preferable, and a solid laser and a semiconductor laser are particularly preferable.

As a developer or a replenisher for the planographic printing plate precursor of the invention, conventional aqueous alkaline solutions can be used.

Examples of the alkali agents include inorganic alkali agents such as sodium silicate, potassium silicate, sodium tertiary phosphate, potassium tertiary phosphate, ammonium tertiary phosphate, dibasic sodium phosphate, dibasic potassium phosphate, dibasic ammonium phosphate, sodium carbonate, potassium carbonate, ammonium carbonate, sodium hydrogen carbonate, potassium hydrogen carbonate, ammonium hydrogen carbonate, sodium borate, potassium borate, ammonium borate, sodium hydroxide, ammonium hydroxide, potassium hydroxide, and lithium hydroxide; and organic alkaline agent such as monomethylamine, dimethylamine, trimethylamine, monoethylamine, diethylamine, triethylamine, monoisoproylamine, diisopropylamine, triisopropylamine, n-butylamine, monoethanolamine, diethanolamine, triethanolamine, monoisopropanolamine, diisopropanolamine, ethylenimine, ethylenediamine, and pyridine. These alkali agents may be used alone or two or more of them in combination.

Particularly preferable developers among the alkali agents are aqueous silicate solutions such as sodium silicate and potassium silicate. The reason for that is because the developability can be adjusted depending on the ratio and the concentration of silicon oxide SiO₂, which is a component of the silicates, and alkali metal oxides M₂O, and alkalimetal silicates described in, for example JP-A No. 54-62004 and JP-B No. 57-7427 are efficiently used.

In the case of carrying out development by using an automatic developing apparatus, it is known that a large quantity of PS plates can be treated without replacing the developer in a developer tank for a long duration by adding, to the developer, aqueous solution (a replenisher) with a higher alkalinity than that of the developer. In the invention, this replenishing method is preferably employed. To promote or suppress the developability of the developer or the replenisher and improve the dispersion of development scum and affinity of the image forming portion of the printing plate to ink, a variety of surfactants and organic solvents may optionally be added.

As preferable surfactants, anionic, cationic, nonionic and amphoteric surfactants can be exemplified. Further, to the developer or the replenisher, reducing agents of such as hydroquinone, resorcin, sodium salt or potassium salt of inorganic acids such as sulfurous acid, hydrogen sulfurous acid, and further organic carboxylic acid, defoaming agents, and water hardening or softening agents may be added.

The printing plate treated by using the developer or the replenisher is washed with water and post-treated with rinsing solutions containing the surfactants or the like, and desensitizing solutions containing gum arabic and starch derivatives. The post-treatment of the image recording material of the invention can be carried out by using these treatments in combinations.

Recently, for rationalization or standardization of the printing plate production work in printing plate-producing or printing industries, automatic developing apparatuses for printing plates have been used widely. An automatic developing apparatuses generally comprise a development section and a post-treatment section. More specifically, an automatic developing apparatus includes a unit for transferring the printing plates, tanks for respective treatment solutions, and a spraying apparatuse. The automatic developing apparatus transfers the exposed printing plates horizontally and at the same time carries out development treatment by spraying the respective treatment solutions pumped up by pumps, to the printing plate, through spray nozzles. Recently, there is also known a method for carrying out treatment by transporting the printing plates by under-solution guide rolls while the printing plates are immersed in the treatment solution tanks filled with the treatment solutions. In such automatic treatment, the replenishers may be replenished to the respective treatment solutions depending on the treatment quantity, operation times, and the like. Alternatively, so-called disposable treatment method in which treatment is carried out using substantially unused treatment solutions can be employed.

(Eliminating Treatment)

In the planographic printing plate precursor of the invention, when there are an unnecessary image part (e.g. film edge trace of original picture film) in a planographic printing plate obtained by image light exposure, developing, washing with water and/or rinsing and/or gumming, the unnecessary image part is eliminated.

Since the invention has the aforementioned intermediate layer containing a specified polymer, even when an intermediate layer excellent in adherability with a recording layer remains at a solid edge part of a non-image part, this is easily removed by such the eliminating treatment, and an excellent image having no stain at a non-image part is formed.

As eliminating treatment, for example, a method of coating an eliminating solution on an unnecessary image part, and allowing this as it is for a prescribed time, and washing this with water described in Japanese Patent Application Publication (JP-B) No. 2-13293 is preferable, and a method of irradiating an active light-ray guided by an optical fiber to an unnecessary image part, followed by developing, described in JP-ANo. 59-174842 can be also utilized.

A general composition of an eliminating solution used in eliminating treatment will be explained below.

An eliminating solution containing an organic solvent for dissolving a recording layer, an acidic substance for preventing stain, and a fluorine-based surfactant is generally preferable. In addition, an eliminating solution can further contain water, a solvent for removing a developing ink such as a printing ink, an image part protecting agent and the like, a wetting agent, a viscosity adjusting agent, a coloring agent, and a surfactant other than the fluorine-based surfactant, if necessary.

Examples of an organic solvent for dissolving a recording layer include lactones (conventional name: cyclic intramolecular ester) such as propiolactone, butyrolactone, valerolactone and hexanolactone, glycols such as methoxyglycol and ethoxyglycol, ketones such as methyl-isobutyl ketone, ethyl-isobutyl ketone, and cyclohexanone, esters such as 2-methoxyethyl acetate, 2-ethoxyethyl acetate, ethyl acetate, and butyl acetate, ethers such as diethylene glycol dimethyl ether, and diethylene glycol diethyl ether, and special solvents such as dimethyl sulfoxide, and dimethylformamide. These organic solvents can be used alone, or two or more kinds may be used together, and it is preferable to add them at 25 to 99.89 mass % relative to total components of an eliminating solution.

Examples of the acidic substance for preventing stain include a fluorine-containing compound such as phosphoric acid, hydrogen fluoride, and zirconate fluoride, citric acid, and lactic acid and, among them, phosphoric acid, and a fluorine-containing compound are preferable and, inter alia, it is particularly preferable to use phosphoric acid from a viewpoint of easiness of waste solution treatment.

These acidic substances can be used alone, or two or more kinds may be used together. An addition amount is preferably 0.1 to 20 mass % and, in the case of phosphoric acid, 0.5 to 15 mass % is preferable.

In addition, there is an advantage that, when 1 to 20 mass % of water is added to an eliminating solution, acidity is increased, and the stain preventing effect is improved and, in the case of a plate after protection gumming for preventing stain, eliminating work can be done without removing a protective gum with water in advance.

As a fluorine-based surfactant used in an eliminating solution, an anionic or nonionic fluorine-based surfactant is preferable, and a nonionic fluorine-based surfactant is particularly preferable. Particularly preferable examples of a nonionic fluorine-based surfactant include a fluoro aliphatic oligomer having a fluoro aliphatic group and a polyoxyalkylene group represented by following formula (I) or (II).
(R_{f})ₘQ[(OR)ₓQ′A]ₙ (I)
[(R_{f})ₘQ{(OR)ₓQ′A′}n]₂ (II)

Wherein, R_{f} represents a fluoro aliphatic group, Q represents a tethering group for covalently binding R and OR, OR represents a polyoxyalkylene group, A represents a monovalent terminal organic group such as an acyl group, an alkyl group, an aryl group, A′ represents A or a single bond provided that, in at least one, R bound to Q is bound to other Q, Q′ represents a binding group for covalently binding A or A′ and R, m represents an integer of 2 or more, n represents an integer of 2 or more, and x represents an integer of 5 or more.

A fluorine-based surfactant used in an eliminating solution which is preferably used in the invention can be obtained as a commercially available product, and examples include FC-430, FC-431 (all manufactured by 3M), Megafax F-141, same F-142, same F-142D, same F-143, same F-144, same F-144S, same F-528, same F-170, same F-171, same F-172, same F-173, same F-177, same F-183, and same F-184 (all manufactured by Dainippon Ink and Chemicals, Incorporated). An amount of a fluorine-based surfactant to be added varies depending on a solvent and other additive to be used, and is preferably 0.01 to 5 mass %, particularly preferably 0.05 to 2 mass % in a total composition of an eliminating solution.

As a preferable kind of a wetting agent which is an arbitrary component contained in an eliminating solution, polyhydric alcohols which are soluble in water, such as glycerin, glycol, and polyglycol are useful. Addition of a wetting agent can help prevent drying of a part to be eliminated due to evaporation of an organic solvent, and retain hydrophilicity until an eliminating solution is removed with water or a developer.

A viscosity adjusting agent is unnecessary in most cases in an eliminating solution which is used before developing, but in an eliminating solution after developing, the viscosity adjusting agent can be added for helping decrease blur of an eliminating solution by reducing flowability of an eliminating solution upon coating of an eliminating solution on a region to be eliminated, and suppressing sagging from a coating equipment such as a brush upon coating, to improve handling property. As such the viscosity adjusting agent, a viscosity adjusting agent which can be completely removed with running water after treatment is preferable, and a viscosity adjusting agent which is a water-soluble resin and is soluble in other eliminating solution component is preferable.

Specific examples include polyvinylpyrrolidone, polyethylene oxide, modified cellulose such as carboxymethylcellulose, and methylcellulose, a polyvinyl acetate/maleic anhydride copolymer, and a polyvinyl methyl ether/maleic anhydride copolymer, and a substance which is a fine powder of silicon dioxide and has a trade name of Aerosil can be also used as a viscosity adjusting agent.

Such the eliminating solution is used when correction is necessary, for example, when a part of an original image is eliminated for use, when an undesired remaining film is generated at a non-image part region, or when a border surface between images remains without exposed in continuous treatment, in various image forming steps, and has great influence in quality of a formed image.

The planographic printing plate produced in such a manner is coated with a desensitizing gum if necessary and supplied to printing steps. In a case where a planographic printing plate with further improved printing durability is to be obtained, burning treatment is optionally carried out.

In the case where the burning treatment of the planographic printing plate is carried out, it is preferable to treat, prior to the burning treatment, the planographic printing plate with surface conditioning solutions described in JP-B Nos. 61-2518 and 55-28062 and JP-A Nos. 62-31859 and 61-159655.

Examples of a method for effecting such a pre-burning treatment include a method of applying the surface conditioning solutions to the planographic printing plate by sponge or degreased cotton doped with the solutions, a method of immersing the printing plate in a vat filled with the surface conditioning solutions, a method of applying the surface conditioning solutions using automatic coaters. In a case where after application the amount of solution applied is made uniform with a squeegee or a squeegee roller, a better result can be obtained.

In general, the amount of surface-adjusting solution applied is suitably from 0.03 to 0.8 g/m² (dry mass). If necessary the planographic printing plate onto which the surface-adjusting solution is applied can be dried, and then the plate is heated to a high temperature by means of a burning processor (for example, a burning processor (BP-1300) sold by Fuji Photo Film Co., Ltd.) or the like. In this case, the heating temperature and the heating time, which depend on the kind of components forming the image, are preferably from 150 to 300° C. and from 1 to 20 minutes, respectively.

If necessary, a planographic printing plate subjected to burning treatment can be subjected to treatments which have been conventionally conducted, such as a water-washing treatment and gum coating. However, in a case where a surface-adjusting solution containing a water soluble polymer compound or the like is used, the so-called desensitizing treatment (for example, gum coating) can be omitted. The planographic printing plate obtained as a result of such treatments is applied to an offset printing machine or to some other printing machine, and is used for printing on a great number of sheets.

### EXAMPLE

The invention will be explained in more detail by way of Examples, but the invention is not limited to them.

[Synthesis of Specified Polymer (P-1)]

A mixed solution of 13.0 g of 2-hydroxyethyl methacrylate (0.1 mol), 7.92 g of pyridine and 200 ml of toluene was added dropwise to a 500 ml three-neck flask containing 21.0 g of trimellitic anhydride chloride (0.1 mol) and 130 ml toluene being stirred under ice-cooling over a period of 30 minutes. Thereafter, the mixture was further reacted at room temperature for 1 hour, the reaction solvent was removed, and precipitated crystals were washed with hexane. 100 ml of water was added to the 24.95 g of the resulting crystals (0.082 mol), and the mixture was stirred, followed by extraction with diisopropyl ether. The solvent was removed from the solution, followed by drying to obtain 15.28 g (yield 47.4%) of a specified monomer (M-1). The structure of the specified monomer (M-1) is shown below.

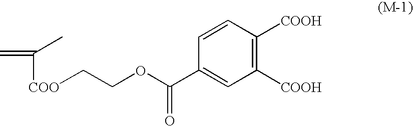

A solution of 22.56 g (0.07 mol) of the specified monomer (M−1), 7.61 g of vinylbenzyltriethylammonium chloride (0.03 mmol), 1.1513 g of dimethyl-2,2′-azobis(2-methylpropionate) (trade name: V-601; manufactured by Wako Pure Chemical Industries, Ltd.)(0.005 mmol), 116.27 g of DMSO and 20.52 g of MeOH was added dropwise to a 300 ml three-neck flask to which 29.07 g of DMSO and 5.13 g of MeOH had been added, over 2 hours under nitrogen atmosphere at 75° C., and the mixture was further reacted for 4 hours. The reaction solution was re-precipitated with acetone, filtered, and dried to obtain 28.96 g of a specified polymer (P-1). The weight average molecular weight of this specified polymer (P-1) was 28,000.

Specified polymers (P-2) to (P-12) were synthesized by appropriately changing raw materials using the same method as that of synthesis of the specified polymer (P-1).

[Manufacturing of Support]

By performing the following treatment using a JIS A 1050 aluminum plate having a thickness of 0.3 mm, a support 1 and a support 2 were manufactured.

(a) Mechanical Surface Roughening Treatment

While a suspension containing a polishing agent (silica sand) with a specific gravity of 1.12 and water is supplied as a polishing slurry to a surface of each aluminum sheet, and mechanical surface roughening is carried out by rotating roller type nylon brushes. The average particle size of the polishing agent is 8 μm and maximum particle size 50 μm. The material of the nylon brushes is 6-10 nylon and hair length and hair diameters are 50 mm and 0.3 mm, respectively. The nylon brushes are produced by implanting the hairs densely in holes formed in stainless cylinders with a diameter of 300 mm. Three rotating brushes are used. Two supporting rollers (200 mm diameter) are placed below the brushes with a separation of 300 mm. The brush rollers are pushed until the load of the driving motor for rotating the brushes is increased by 7 kW or more from the load before pushing the brush rollers against the aluminum sheet. The rotation direction of the brushes is the same as the moving direction of the aluminum sheet. The rotation speed of the brushes is 200 rpm.

(b) Alkaline Etching Treatment

Etching treatment is carried out by spraying an aqueous NaOH solution (concentration 26% by weight and an aluminum ion concentration 6.5% by weight) at 70° C. to the obtained aluminum sheet in order to dissolve an amount of 6 g/m² aluminum sheet. After that, the aluminum sheet is washed with water by spraying.

(c) Desmut Treatment

Desmut treatment is carried out by spraying an aqueous solution of 1% by weight nitric acid (containing an aluminum ion concentration of 0.5% by weight) at 30° C. and then the resulting aluminum sheet is washed with water. As the aqueous nitric acid solution used for desmut, waste solution from a process of electrochemical surface roughening in an aqueous nitric acid solution by AC (alternate current) can be used.

(d) Electrochemical Surface Roughening Treatment

Electrochemical surface roughening treatment can be carried out continuously by using 60 Hz AC voltage. The electrolytic solution used in this case is an aqueous solution of nitric acid 10.5 g/L (aluminum ion 5 g/L) at 50° C. The electrochemical surface roughening can be carried out using an AC power waveform which is a trapezoidal rectangular waveform, with the time TP from a zero current value to a peak being 0.8 msec and Duty ratio 1:1, and employing a carbon electrode as an opposed electrode. Ferrite is used as an auxiliary anode. A radial cell type electrolytic bath is used.

The current density is 30 A/dm² at the peak value of the current and the total electricity quantity is 220 C/dm² when aluminum sheet is used as an anode. Five percent of the electric current flowing from the electric power was shunted through the auxiliary anode.

After that, the resulting aluminum sheet is washed with a water spray.

(e) Alkali Etching Treatment

Etching treatment can be carried out on the aluminum sheet at 32° C. by spraying a solution with sodium hydroxide concentration 26% by weight and aluminum ion concentration 6.5% by weight. By doing this 0.2 g/m² of the aluminum sheet is dissolved so as to remove the smut component of mainly aluminum hydroxide produced when carrying out the electrochemical surface roughening by using alternating current in the prior step. It also has the effect of dissolving the edge parts of formed pits so as to smooth the edge parts. After that, the aluminum sheet is washed by water spray.

(f) Desmut Treatment

Desmut treatment is carried out by spraying an aqueous solution of 15% by weight nitric acid (containing aluminum ion 4.5% by weight) at 30° C. and then the resulting aluminum sheet is washed by water spray. For the aqueous nitric acid solution used for the desmut, waste solution from the process of electrochemical surface roughening in an aqueous nitric acid solution by AC can be used.

(g) Electrochemical Surface Roughening Treatment

Electrochemical surface roughening treatment can be carried out continuously by using 60 Hz AC voltage. The electrolytic solution used in this case is an aqueous solution of hydrochloric acid 7.5 g/L (containing aluminum ion 5 g/L) at 35° C. The AC power waveform is a rectangular waveform and a carbon electrode is used as an opposed electrode for the electrochemical surface roughening treatment. Ferrite is used as an auxiliary anode. A radial cell type electrolytic bath was used.

The current density is 25 A/dm² at the peak value of the current and the total electricity quantity was 50 C/dm² when aluminum sheet is used as an anode.

After that, the resulting aluminum sheet is washed with a water spray.

(h) Alkali Etching Treatment

Etching treatment is carried out at 32° C. for aluminum sheet by spraying a solution, of sodium hydroxide concentration 26% by weight and aluminum ion concentration 6.5% by weight, to dissolve 0.10 g/m² of the aluminum sheet. This removes the smut, of which the main is component aluminum hydroxide, produced when the electrochemical surface is roughened by using alternating current in the prior step. Also it dissolves the edge parts of formed pits so as to smooth the edge parts. After that, the aluminum sheet is washed by water spray.

(i) Desmut Treatment

Desmut treatment is carried out by spraying with an aqueous solution of 25% by weight sulfuric acid (containing aluminum ion 0.5% by weight) at 60° C. and then washing the resulting aluminum sheet by water spray.

(j) Anodization Treatment

As an electrolytic solution, sulfuric acid is used. The electrolytic solution contains sulfuric acid 170 g/L (aluminum ion 0.5% by weight) and should be at 43° C. Then the aluminum sheet is washed with a water spray.

The electric current density is about 30 A/dm². Final oxide film thickness is about 2.7 g/m².

(k) Alkali Metal Silicate Treatment

Aluminum supporting bodies obtained by anodization are immersed in a treatment bath of an aqueous solution containing No. 3 sodium silicate 1% by weight for 10 seconds at 30° C. to carry out alkali metal silicate treatment (silicate treatment). After that, the support is washed by water spray. The silicate deposition is about 3.5 mg/m².

<Support 1>

Respective processes (a) to (k) were sequentially performed, and the etching amount in process (e) was adjusted to 3.5 g/m², thereby, manufacturing a support 1.

<Support 2>

The above respective processes were sequentially performed except that processes (g), (h), and (i) among the aforementioned processes were omitted, and a support 2 was manufactured.

[Formation of Intermediate Layer]

The following coating solution for forming an intermediate layer was coated on the support manufactured as described above (which support was used is described in Table 1), and this was dried at 80° C. for 15 seconds to provide an intermediate layer. A coating amount after drying was 15 mg/m².

<Coating solution for forming intermediate layer>

| | | |
|---|---|---|
| Specified polymer (exemplified compound) | 0.3 | g |
| or comparative polymer described in Table 1 | | |
| Methanol | 100 | g |
| Water | 1 | g |

### Examples 1, 3, 4 and 7

[Formation of Recording Layer]

-Synthesis of Polymer 1-

A 500 ml three-neck flask equipped with a stirrer, a condensing tube and an addition funnel was charged with 31.0 g (0.36 mole) of methacrylic acid, 39.1 g (0.36 mole) of ethyl chloroformate and 200 ml of acetonitrile, and the mixture was stirred while it was cooled with an ice water bath. To this mixture was added dropwise 36.4 g (0.36 mole) of triethylamine over about 1 hour with the addition funnel. After addition, the ice water bath was removed, and the mixture was stirred at room temperature for 30 minutes.

To this reaction mixture was added 51.7 g (0.30 mole) of p-aminobenzenesulfonamide, and the mixture was stirred for 1 hour while it was warmed to 70° C. with an oil bath. After completion of the reaction, this mixture was placed into 1 liter of water while this water was stirred, and the resulting mixture was stirred for 30 minutes. This mixture was filtered to remove precipitates, which were slurried with 500 ml of water, and this slurry was filtered, and the resulting solid was dried to obtain a white solid of N-(p-aminosulfonylphenyl)methacrylamide (yield 46.9 g).

Then, a 200 ml three-neck flask equipped with a stirrer, a condensing tube and an addition funnel was charged with 4.61 g (0.0192 mole) of N-(p-aminosulfonylphenyl)methacrylamide, 2.58 g (0.0258 mole) of ethyl methacrylate, 0.80 g (0.015 mole) of acrylonitrile and 20 g of N,N-dimethylacetamide, and the mixture was stirred while it was heated to 65° C. with a hot water bath. To this mixture was added 0.15 g of 2,2′-azobis(2,4-dimethylvaleronitrile) (trade name: “V-65”, manufactured by Wako Pure Chemical Industries, Ltd.) as a polymerization initiator, and the mixture was stirred for 2 hours under a nitrogen stream while it was maintained at 65° C. To this reaction mixture was further added dropwise a mixture of 4.61 g of N-(p-aminosulfonylphenyl)methacrylamide, 2.58 g of methyl methacrylate, 0.80 g of acrylonitrile, 20 g of N,N-dimethylacetamide and 0.15 g of the “V-65” through an addition funnel over a period of 2 hours. After completion of addition, the resulting mixture was further stirred at 65° C. for 2 hours. After completion of the reaction, 40 g of methanol was added to the mixture, this was cooled, the resulting mixture was placed into 2 liters of water while this water was stirred, the mixture was stirred for 30 minutes, and precipitates were removed by filtration, and dried to obtain 15 g of a white solid. A weight average molecular weight (polystyrene standard) of this specified copolymer 1 was measured by gel permeation chromatography, and was found to be 54,000.

The following coating solution 1 for forming a recording layer was coated on the thus formed intermediate layer at a coating amount of 0.85 g/m², and this was dried at 110° C. for 50 seconds with a PERFECT OVEN PH200 manufactured by TABAI by setting Wind Control at 7. Thereafter, the coating solution 2 for forming a recording layer was coated at a coating amount of 0.30 g/m², and this was dried at 120 degrees for 1 minute to obtain each of planographic printing plate precursors of Examples 1, 3, 4 and 7.

<Coating solution 1 for forming recording layer>

| | |
|---|---|
| The copolymer 1 | 2.133 g |
| Cyanine dye A (having the following structure) | 0.109 g |
| 4,4′-Bishydroxyphenylsulfone | 0.126 g |
| Tetrahydrophthalic anhydride | 0.190 g |
| p-toluenesulfonic acid | 0.008 g |
| 3-Methoxy-4-diazodiphenylamine hexafluorophosphate | 0.030 g |
| Ethyl violet in which the counterion was | 0.100 g |
| changed to the anion of 6-hydroxy-2-naphthalenesulfonic acid | |
| Megafac F780, manufactured by Dainippqn Ink and Chemicals, | 0.035 g |
| Incorporated | |
| (Coated surface improving fluorine-based surfactant) | |
| Methyl ethyl ketone | 25.38 g |
| 1-Methoxy-2-propanol | 13.0 g |
| gamma-Butyrolactone | 13.2 g |

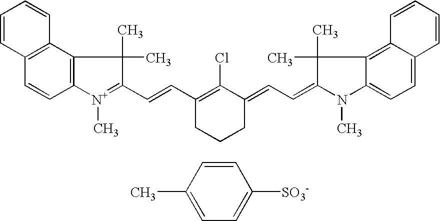

Cyanine dye A

<Coating solution 2 for forming recording layer>

| | |
|---|---|
| m,p-cresol novolak | 0.3478 g |
| (m/p ratio = 6/4, weight average molecular weight 4500, | |
| containing 0.8 mass % of unreacted cresol) | |
| Cyanine dye A (having the above structure) | 0.0192 g |
| Onium salt B (having the following structure) | 0.0115 g |
| Megafac F780 (20%), manufactured by | 0.022 g |
| Dainippon Ink and Chemicals, Incorporated | |
| (Surface improving surfactant) | |
| Methyl ethyl ketone | 13.07 g |
| 1-Methoxy-2-propanol | 6.79 g |

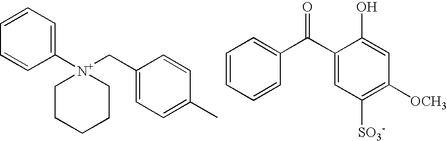

Onium salt B

### Examples 2, 5 and 6

The following coating solution 3 for forming a recording layer was coated on the thus formed intermediate layer at a coating amount after drying of 1.2 g/m², to obtain each of planographic printing plate precursors of Examples 2, 5 and 6.

<Coating solution 3 for forming recording layer>

| | |
|---|---|
| m,p-cresol novolak | 0.93 g |
| (m/p ratio = 6/4, weight average molecular weight 7,300, | |
| containing 0.4 mass % of unreacted cresol) | |
| Vinyl polymer (1) having the following structure | 0.07 g |
| Cyanine dye A (having the above structure) | 0.017 g |
| Cyanine dye B (having the following structure) | 0.023 g |
| 2,4,6-Tris(hexyloxy)benzenediazonium-2-hydroxy- | 0.01 g |
| 4-methoxybenzophenone-5-sulfonate | |
| p-toluenesulfonic acid | 0.003 g |
| Cyclohexane-1,2-dicarboxylic anhydride | 0.06 g |
| Dye of Victoria Pure Blue BOH in which the | 0.015 g |
| counteranion was changed to 1-naphthalenesulfonic acid anion | |
| Fluorine-based surfactant | 0.02 g |
| (Megafac F-176, manufactured by Dainippon Ink and | |
| Chemicals, Incorporated) | |
| Methyl ethyl ketone | 15 g |
| 1-Methoxy-2-propanol | 7 g |

Cyanine dye B

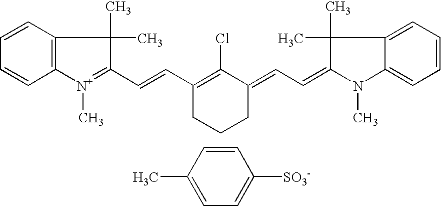

Vinyl polymer (1)

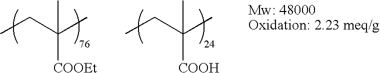

### Comparative Example 1

According to the same manner as that of Example 1, except that the Example 1 intermediate layer was not provided, a planographic printing plate precursor of Comparative Example 1 was obtained.

### Comparative Example 2

According to the same manner as that of Example 1, except that a comparative polymer (PA-0) having the following structure was used in place of the Example 1 specified polymer (P-1) in the coating solution for forming an intermediate layer, a planographic printing plate precursor of Comparative Example 2 was obtained.

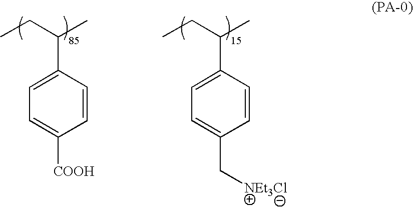

### Comparative Example 3

According to the same manner as that of Example 5, except that the comparative polymer (PA-0) having the above structure was used in place of the Example 8 specified polymer (P-8) in the coating solution for forming an intermediate layer, a planographic printing plate precursor of Comparative Example 3 was obtained.

[Evaluation]

Resulting respective planographic printing plate precursors of Examples 1 to 7, and Comparative Examples 1 to 3 were assessed for printing durability, removability, and resistance to staining of non-image parts as follows.

1. Evaluation of Printing Durability

Resulting respective planographic printing plate precursors of Examples 1 to 7, and Comparative Examples 1 to 3 were subjected to imagewise exposure at a plate surface energy amount of 140 mJ/cm² using TrendSetter 3244 manufactured by CREO.

Then, planographic printing plate precursors of Examples 1 to 3, 5 and 7, and Comparative Examples 1 to 3 were developed with an automatic developing machine 900NP using a PS plate developer “DT-2” manufactured by Fuji Photo Film Co., Ltd. which is a developer containing substantially no alkali metal silicate salts under standard use conditions, to obtain each of planographic printing plates. Resulting respective planographic printing plates were printed with a Lithron printing machine manufactured by Komori Corporation using DIC-GEOS(N) black ink manufactured by Dainippon Ink and Chemicals, Incorporated, and printing durability was assessed by the number of sheets printed when the concentration of a solid image began to be visibly thinned. Results are shown in Table 1.

In addition, planographic printing plate precursors of Examples 4 and 6 were assessed by developing using a developer containing alkali metal silicate salts (PS plate developer “DP-4” manufactured by Fuji Photo Film Co., Ltd.) in the same way as described above.

2. Evaluation of Removability

Using respective planographic printing plates obtained by exposure and developing as in the 1, a removing solution having the following formulation was put on a calligraphy-brush or made to exude out from a pen depending on the coating area, was coated on a region on a planographic printing plate in which a film edge remained as an image, or on an image part that was not required. This was allowed to stand for 30 seconds, and then this was washed away by water spray. The resulting planographic printing plate after removal treatment was printed with a Lithron printing machine manufactured by Komori Corporation using DIC-GEOS(N) black ink manufactured by Dainippon Ink and Chemicals, Incorporated, and eliminability of image parts not required was confirmed visually from a printed article, and assessment was performed based on the following criteria. Results are shown in Table 1.

A: Image parts not required completely removed.

B: Image parts not required not completely removed, and smudging occurs.

<Removing solution composition>

| | | |
|---|---|---|
| Propylene carbonate | 10.0 | parts by mass |
| Ethylene carbonate | 40.0 | parts by mass |
| Dimethyl sulfoxide | 33.3 | parts by mass |
| Pure water | 8.4 | parts by mass |
| Zircon hydrofluoric acid | 2.4 | parts by mass |
| (40 mass % aqueous solution) | | |
| Triethanolamine | 1.2 | parts by mass |
| Powdery silicon dioxide | 4.7 | parts by mass |

3. Evaluation of Resistance to Staining of Non-Image Parts

Resulting respective planographic printing plate precursors of Examples 1 to 7, and Comparative Examples 1 to 3 were subjected to imagewise exposure at a setter exposure amount of 8.0 W and 150 rpm using TrendSetter 3244F manufactured by CREO.

Then, respective planographic printing plate precursors of Examples 1 to 3, 5 and 7, and Comparative Examples 1 to 3 were developed with an automatic developing machine 900 NP using a PS plate developer DT-2 manufactured by Fuji Photo Film Co., Ltd. which is a developer containing substantially no alkali metal silicate salts under standard use conditions, and respective planographic printing plate precursors of Examples 4 and 6 were developed with an automatic developing machine 900NP using a developer containing alkali metal silicate salts (PS plate developer DP-4 manufactured by Fuji Photo Film Co., Ltd.) under standard use conditions. Thereby, the respective planographic printing plates of Examples 1 to 7, and Comparative Examples 1 to 3 were obtained.

Respective planographic printing plates obtained by the above method were printed with a Mitsubishi Dia-type F2 printing machine (manufactured by Mitsubishi Heavy Industries) using an ink of DIC-GEOS (s) rouge, and the staining of the blanket after printing 10000 sheets was visually assessed.

Assessment criteria was as follows: no staining, or slight staining is shown as A, and significant staining is shown by B. Results are shown in Table 1.

TABLE 1

| | | | | | | | Resistance |
|---|---|---|---|---|---|---|---|
| | | Polymer | Coating | | Printing | | to |
| | | contained | solution | | durability | | staining |
| | | in | for | | (units | | of non- |
| | | intermediate | photosensitive | | 10000 | | image |
| | Support | layer | layer | Developer | sheets) | Removability | parts |
| Example 1 | 1 | (P-1) | Coating | DT-2 | 9.5 | A | A |
| | | | solution | | | | |
| | | | 1, 2 | | | | |
| Example 2 | 2 | (P-2) | Coating | DT-2 | 9.0 | A | A |
| | | | solution 3 | | | | |
| Example 3 | 2 | (P-6) | Coating | DT-2 | 9.0 | A | A |
| | | | solution | | | | |
| | | | 1, 2 | | | | |
| Example 4 | 1 | (P-4) | Coating | DT-4 | 10.0 | A | A |
| | | | solution | | | | |
| | | | 1, 2 | | | | |
| Example 5 | 1 | (P-8) | Coating | DT-2 | 9.0 | A | A |
| | | | solution 3 | | | | |
| Example 6 | 1 | (P-4) | Coating | DT-4 | 10.0 | A | A |
| | | | solution 3 | | | | |
| Example 7 | 2 | (P-9) | Coating | DT-2 | 9.5 | A | A |
| | | | solution | | | | |
| | | | 1, 2 | | | | |
| Comparative | 1 | — | Coating | DT-2 | 5.0 | B | B |
| Example 1 | | | solution | | | | |
| | | | 1, 2 | | | | |
| Comparative | 1 | (PA-0) | Coating | DT-2 | 7.0 | A | A |
| Example 2 | | | solution | | | | |
| | | | 1, 2 | | | | |
| Comparative | 1 | (PA-0) | Coating | DT-2 | 7.0 | A | A |
| Example 3 | | | solution 3 | | | | |

As shown in Table 1, it is seen that respective planographic printing plate precursors of Examples 1 to 7 containing a specified polymer in an intermediate layer are excellent in printing durability and removability, and are further excellent in resistance to staining of non-image parts.

On the other hand, it is seen that Comparative Example 1 in which an intermediate layer was not provided, has problems with removability and resistance to staining of non-image parts, and is significantly inferior in printing durability as compared with the Examples. In addition, it is seen that in Comparative Example 2 and Comparative Example 3 using a polymer outside of the scope of the invention in an intermediate layer, there is no problem with removability and resistance to staining of non-image parts, but printing durability is low compared with the Examples.

What is claimed is:

1. A planographic printing plate precursor, comprising:
a support;
an intermediate layer containing a polymer having on a side chain an aromatic ring having two or more carboxylic acid groups, which layer is provided on the support; and
an infrared-ray laser photosensitive positive-type recording layer provided on the intermediate layer.

2. The planographic printing plate precursor according to claim 1, wherein the polymer is obtained by polymerizing or copolymerizing a monomer having an aromatic ring having two or more carboxylic acid groups.

3. The planographic printing plate precursor according to claim 2, wherein the monomer contains a polymerizable double bond, and an aromatic ring having two or more carboxylic acid groups.

4. The planographic printing plate precursor according to claim 3, wherein the polymerizable double bond of the monomer and the aromatic ring having two or more carboxylic acid groups are connected with a single bond.

5. The planographic printing plate precursor according to claim 3, wherein the polymerizable double bond of the monomer and the aromatic ring having two or more carboxylic acid groups are connected with a divalent linking group.

6. The planographic printing plate precursor according to claim 5, wherein the divalent linking group for connecting the polymerizable double bond and the aromatic ring having two or more carboxylic acid groups contains a partial structure containing one or more hetero atoms.

7. The planographic printing plate precursor according to claim 1, wherein the aromatic ring having two or more carboxylic acid groups is any of a hydrocarbon aromatic ring, a heterocyclic aromatic ring, or a polycyclic aromatic compound comprising a plurality of aromatic rings which may be hydrocarbon aromatic and/or heterocyclic aromatic rings.

8. The planographic printing plate precursor according to claim 7, wherein the aromatic ring having two or more carboxylic acid groups is a hydrocarbon aromatic ring.

9. The planographic printing plate precursor according to claim 8, wherein the aromatic ring having two or more carboxylic acid groups is phthalic acid or isophthalic acid.

10. A planographic printing plate precursor, comprising:
a support;
an intermediate layer containing a specified polymer, which is provided on or above the support; and
an infrared-ray laser photosensitive positive-type recording layer provided on or above the intermediate layer,
wherein the specified polymer has a plurality of side chains, and the end of each side chain is an aromatic ring having two or more carboxylic acid groups.

11. The planographic printing plate precursor according to claim 10, wherein the aromatic ring(s) having two or more carboxylic acid groups and the main chain of the specified polymer are connected with a single bond.

12. The planographic printing plate precursor according to claim 10, wherein the aromatic ring(s) having two or more carboxylic acid groups and the main chain of the specified polymer are connected with a divalent linking group.

13. The planographic printing plate precursor according to claim 12, wherein the divalent linking group contains a partial structure containing one or more hetero atoms.

14. The planographic printing plate precursor according to claim 1, wherein the aromatic ring having two or more carboxylic acid groups is any one of a hydrocarbon aromatic ring, a heterocyclic aromatic ring, or a polycyclic aromatic compound comprising a plurality of aromatic rings which may be ydrocarbon aromatic and/or heterocyclic aromatic rings.

15. The planographic printing plate precursor according to claim 14, wherein the aromatic ring having two or more carboxylic acid groups is a hydrocarbon aromatic ring.

16. The planographic printing plate precursor according to claim 15, wherein the aromatic ring having two or more carboxylic acid groups is phthalic acid or isophthalic acid.
